(19) United States
(12) Patent Application Publication
(10) Pub. No.: US 2025/0315025 A1
(43) Pub. Date: Oct. 9, 2025

(54) COMMAND LIST CREATING DEVICE, INFORMATION CREATING DEVICE, SCREEN CREATING DEVICE, DRAWING CREATING DEVICE, COMMAND LIST CREATING METHOD, INFORMATION CREATING METHOD, DRAWING CREATING PROGRAM, AND RECORDING MEDIUM

(71) Applicant: Nippon Electric Glass Co., Ltd., Otsu-shi, Shiga (JP)

(72) Inventor: Noriaki ORITA, Otsu-shi (JP)

(73) Assignee: Nippon Electric Glass Co., Ltd., Otsu-shi, Shiga (JP)

(21) Appl. No.: 18/865,411

(22) PCT Filed: May 12, 2023
(86) PCT No.: PCT/JP2023/017886

§ 371 Date: Nov. 13, 2024

(30) Foreign Application Priority Data
May 18, 2022 (JP) 2022-081735

(51) Int. Cl. G05B 19/05

(52) U.S. Cl. CPC G05B 19/056

(57) ABSTRACT

A PC includes a generation section that: associates a command which defines sequence control carried out by a PLC and a device of an apparatus connected to the PLC, based on sequence information which describes, in operation order of the apparatus a sequence name including an apparatus name of the apparatus and an operation name of an operation of the apparatus; and generates a command list. The generation section includes: a command identifying section that refers to command collation information in which a correspondence relation between the sequence name and the command is defined, and identifies the command corresponding to the sequence name sequentially read out from the sequence information; and a device identifying section that identifies, with reference to apparatus collation information in which a correspondence relation between the apparatus name and the device is defined, the device corresponding to the apparatus name included in the sequence name.

### TECHNICAL FIELD

The present invention relates to, for example, a command list creating device for creating a command list to be used in creating a ladder program and the like.

### BACKGROUND ART

A control device, like a programmable logic controller (PLC), that carries out a sequence control operates according to a sequence program in which a procedure of control is described. As the sequence program, for example, a ladder program is known.

In creation of the ladder program, programming software for creating the ladder program in the form of a ladder diagram is used. In general, programming software is implemented on a personal computer (PC). Such a PC functions as a program creation assist device that assists creation of a ladder program, as disclosed in Patent Literature 1.

### CITATION LIST

### Patent Literature

### Patent Literature 1

Japanese Patent Application Publication Tokukai No. 2017-188115

### SUMMARY OF INVENTION

### Technical Problem

In creating a ladder program with use of a program creation assist device as described above, design information is created in advance. In the design information, operations of apparatuses that constitute production equipment are designed. The design information includes, for example, various apparatuses to be used and the order of operations of such apparatuses. Then, a creator of a ladder program performs a programming task on the basis of the design information, with use of the program creation assist device. The programming task is performed by manual input made by the creator with reference to the design information. For this reason, there has been problems in that the programming task is time-consuming and that a typographical error occurs.

Further, the design information is used for not only creating the ladder program but also creating various information to be used in, for example, construction and operation of the production equipment. For example, the design information is used in creating a screen that is to be displayed on an operation display device. The operation display device includes a touch panel and a display device. In cooperation with a control device, the operation display device displays, on the display device, a state of the production equipment on the basis of data acquired from the control device, and gives a control command to the control device via the touch panel. In general, creation of a screen is carried out with use of a PC on which screen creation software is implemented. Creation of a screen, like creation of a ladder program, is performed by manual input made by a creator of the screen with reference to the design information. Further, no portion of a task in creation of a screen can be commonly used in creation of a ladder program, and the task of the creation of the screen is performed as a task that is completely different from that of the creation of a ladder program. Accordingly, there has been a problem in that creation of a screen is time-consuming.

In this way, the design information is used only for reference by a creator when a ladder program or a screen is created. The design information has not been prepared in a form in which the design information contributes to efficiency of creation.

An object of an aspect of the present invention is to effectively utilize design information.

### Solution to Problem

In order to solve the above problem, a command list creating device according to an aspect of the present invention includes a generation section that associates (i) a command which defines sequence control carried out by a control device and (ii) identification information of an apparatus connected to the control device and generates a command list, on the basis of sequence information which describes, in operation order of the apparatus, a compound name indicating an operation of the apparatus, the compound name including an apparatus name that indicates the apparatus and an operation name that indicates the operation of the apparatus, the generation section including: a command identifying section that refers to command collation information in which a correspondence relation between the compound name and the command is defined in advance, and identifies the command corresponding to the compound name that was sequentially read out from the sequence information; and an identification information identifying section that refers to apparatus collation information in which a correspondence relation between the apparatus name and the identification information is defined in advance, and identifies the identification information corresponding to the apparatus name included in the compound name that was read out.

In order to solve the above problem, a command list creating method according to the present invention includes a generation step of associating (i) a command which defines sequence control carried out by a control device and (ii) identification information of an apparatus connected to the control device and generating a command list, on the basis of sequence information which describes, in operation order of the apparatus, a compound name indicating an operation of the apparatus, the compound name including an apparatus name that indicates the apparatus and an operation name that indicates the operation of the apparatus, the generation step including: a command identifying step of referring to command collation information in which a correspondence relation between the compound name and the command is defined in advance, and identifying the command corresponding to the compound name that was sequentially read out from the sequence information; and an identification information identifying step of referring to apparatus collation information in which a correspondence relation between the apparatus name and the identification information is defined in advance, and identifying the identification information corresponding to the apparatus name included in the compound name that was read out.

### Advantageous Effects of Invention

According to an aspect of the present invention, design information can be effectively utilized.

### BRIEF DESCRIPTION OF DRAWINGS

FIG. 1 is a block diagram illustrating a configuration of a ladder program creating system in accordance with Embodiment 1 of the present invention.

FIG. 2 is a diagram illustrating a configuration of an input form that is to be used in creation of design information by a PC for creating the design information in the ladder program creating system.

FIG. 3 is a diagram showing a part of the input form in which apparatus collation information on positions of servomotors in the design information is written.

FIG. 4 is a diagram showing a part of the input form in which apparatus collation information on speeds of servomotors in the design information is written.

FIG. 5 is a diagram showing a part of the input form in which apparatus collation information on acceleration/deceleration times of servomotors in the design information is written.

FIG. 6 is a diagram showing a part of the input form in which apparatus collation information on an input apparatus(es) in the design information is written.

FIG. 7 is a diagram showing a part of the input form in which apparatus collation information on an output apparatus(es) in the design information is written.

FIG. 8 is a diagram illustrating a configuration of a re-packer for which sequence information in the design information is to be created.

FIG. 9 is a diagram showing a part of the input form in which the sequence information of the re-packer is written.

FIG. 10 is a diagram illustrating a command list that is created by a PC for creating the command list in the ladder program creating system.

FIG. 11 is a flowchart illustrating a procedure of creation of the command list by a PC for creating the command list.

FIG. 12 is a diagram showing a ladder program regarding a present value of a servomotor.

FIG. 13 is a diagram showing a ladder program regarding a present position of a servomotor.

FIG. 14 is a diagram showing a ladder program regarding interlock.

FIG. 15 is a diagram showing a ladder program regarding setting a target position and a movement amount of a servomotor.

FIG. 16 is a diagram showing a ladder program regarding setting an origin of a servomotor.

FIG. 17 is a diagram showing a ladder program regarding JOG activation of a servomotor.

FIG. 18 is a diagram showing a ladder program regarding an activation command of a servomotor.

FIG. 19 is a diagram showing a ladder program regarding a process at the time when a fault occurs.

FIG. 20 is a diagram showing a ladder program regarding fault detection by a sensor.

FIG. 21 is a diagram showing a ladder program regarding a manual operation.

FIG. 22 is a diagram showing a ladder program regarding an operation of an output circuit.

FIG. 23 is a diagram showing a ladder program regarding an automatic operation.

FIG. 24 is a block diagram illustrating a configuration of a screen creating system in accordance with Embodiment 2 of the present invention.

FIG. 25 is a diagram showing a device list to be used in a PC for creating a screen in the screen creating system.

FIG. 26 is a diagram showing a device list which is obtained when the PC for creating a command list outputs, in CSV format, a portion listing devices on the command list.

FIG. 27 is a diagram showing a character notation list which is obtained when the PC for creating a command list outputs, in the CSV format, a portion listing comments on the command list.

FIG. 28 is a flowchart showing a procedure of creation of a screen by the PC for creating a screen.

FIG. 29 is a diagram showing an I/O monitor screen.

FIG. 30 is a diagram showing a tracking screen.

FIG. 31 is a diagram showing an arm Z information display screen.

FIG. 32 is a diagram showing a fault display screen.

FIG. 33 is a block diagram illustrating a configuration of a diagram creating system in accordance with Embodiment 3 of the present invention.

FIG. 34 is a diagram showing an apparatus information list that is created by the PC.

FIG. 35 is a diagram showing a current value list that is created by the PC.

FIG. 36 is a flowchart illustrating a procedure of creation of a diagram by a PC for creating a diagram in the diagram creating system.

FIG. 37 is a diagram showing a diagram template that has been prepared by the PC and diagram data that was created by the PC on the basis of the diagram template.

FIG. 38 is a diagram showing another diagram template that has been prepared by the PC for creating a diagram in the diagram creating system and other diagram data that was created by the PC on the basis of the diagram template.

### Description of Embodiments

### Embodiment 1

The following description will discuss an embodiment of the present invention in detail.

### Overview of Ladder Program Creating System 1001

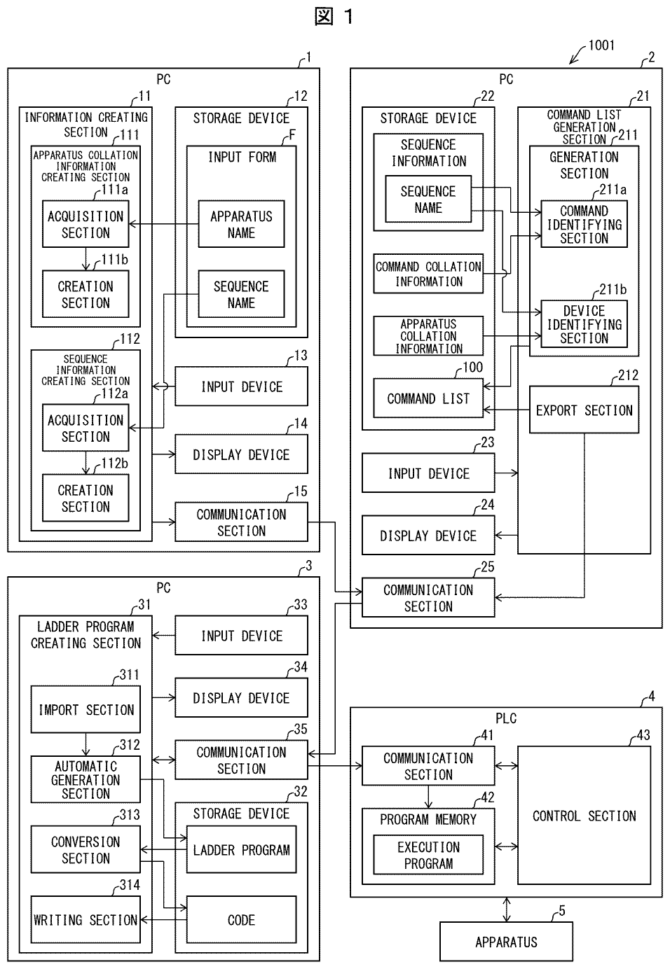

FIG. 1 is a block diagram illustrating a configuration of a ladder program creating system 1001 in accordance with Embodiment 1.

As illustrated in FIG. 1, the ladder program creating system 1001 includes a PC 1 (information creating device), a PC 2 (command list creating device), and a PC 3. The PCs 1 to 3 are each a personal computer. Although not illustrated, the PCs 1 to 3 each have, for example, a central processing unit (CPU), a random access memory (RAM), a read only memory (ROM), an auxiliary storage device(s) (e.g., HHD and/or SSD), a display device, an input device, and a communication device.

The ladder program creating system 1001 first creates design information, then creates a command list 100 on the basis of the design information, and automatically creates a ladder program on the basis of the command list 100. The ladder program thus created is written in a PLC 4.

The PLC 4 is a control device that monitors and controls an apparatus(es) 5 that constitutes a main part of production equipment. The PLC 4 has a communication section 41, a program memory 42, and a control section 43. The communication section 41 receives, from the PC 3, the ladder program that has been created by the PC 3. The program memory 42 stores the ladder program that has been received by the communication section 41. The control section 43 reads out a state of the apparatus 5 and gives a control instruction to the apparatus 5 every predetermined scanning time according to a control procedure that is defined in the ladder program.

The command list is a list in which a command that defines sequence control to be carried out by the PLC 4 and a device (identification information) of the apparatus 5 are associated with each other. The command list will be described in detail later.

The apparatus 5 is connected to the PLC 4, and operates. As the apparatus(es) 5, for example, an operation apparatus, an input apparatus, and an output apparatus are provided.

The operation apparatus is an apparatus device, such as a cylinder, that operates according to ON/OFF of a signal. Further, the operation apparatus is an apparatus capable of carrying out a complicated operation by a dedicated controller, and is, for example, an apparatus 5 that operates according to control of a servo amplifier (controller), like a servomotor. In a device (e.g., a robot arm, an X-Y table, and/or a conveyance device) that requires multiaxial control, a plurality of servomotors are used.

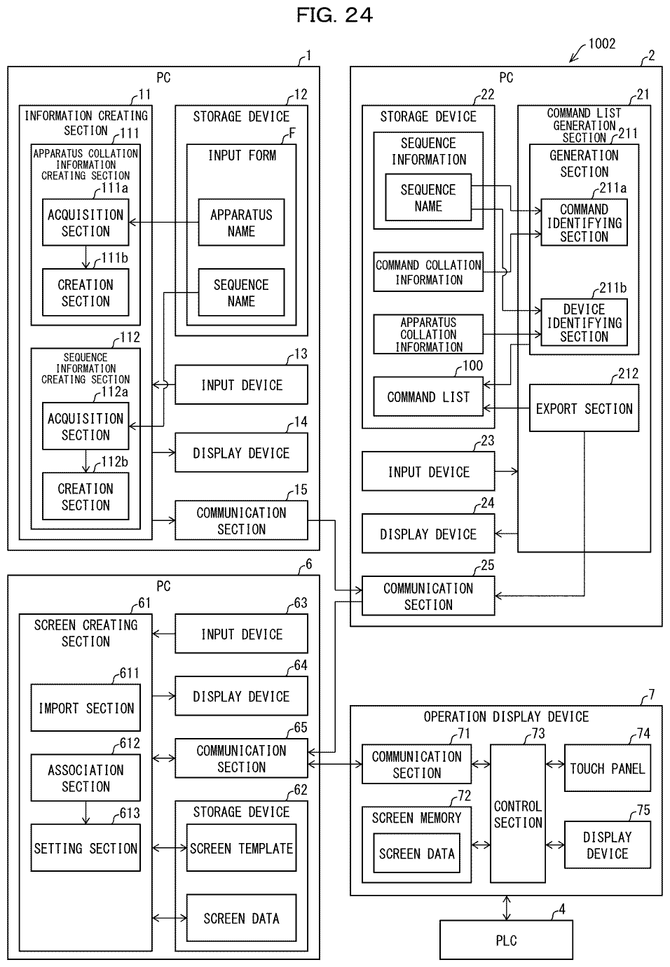

The input apparatus outputs an input signal to the PLC 4. Examples of the input apparatus include a push-button switch, a sensor, and a touch switch that is displayed on an operation display device 7 (see FIG. 24) described later. The output apparatus is given the output signal from the PLC 4. Examples of the output apparatus include a lamp, an electromagnetic valve, and a motor (motor excluding servomotors).

### (Configuration of PC 1)

The PC 1 is configured as an information creating device for creating design information. In order to create the design information, the PC 1 includes an information creating section 11, a storage device 12, an input device 13, a display device 14, and a communication section 15.

The information creating section 11 creates the design information in response to an input operation made by a user via the input device 13, and causes the display device 14 to display the design information. Further, the information creating section 11 causes the communication section 15 to transmit, to the PC 2, the design information that has been created.

The design information is information in which an operation of an apparatus 5 disposed in production equipment is designed, and includes apparatus collation information and sequence information. The apparatus collation information and the sequence information will be described in detail later.

The information creating section 11 provides, as a user interface, for example, a dedicated input form F that allows a user to create the design information by entering necessary information. The input form F is stored in the storage device 12. As the input form F, a sheet of spreadsheet software can be used. In this case, the input form F can be formed in a tabular format, and thus can be easily introduced. The input form F is not limited thereto, but may be formed, for example, in HyperText Markup Language (HTML) format, comma separated values (CSV), text, determinant, form format, or visual programming format.

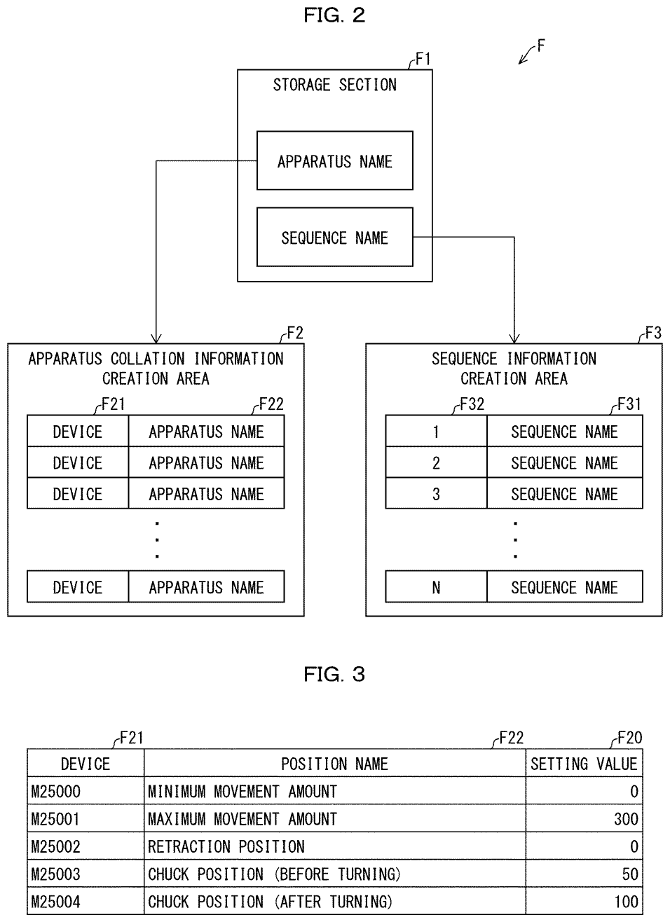

Here, the following will describe the input form F. FIG. 2 is a diagram illustrating a configuration of the input form F that is to be used in creation of the design information by the PC 1.

As illustrated in FIG. 2, the input form F includes a storage section F1, an apparatus collation information creation area F2, and a sequence information creation area F3.

The storage section F1 stores an apparatus name and a sequence name as a compound name. The apparatus name is a name that indicates the apparatus 5. The apparatus name may be not only a name that indicates the name of the apparatus 5 itself but also a name that indicates a function of the apparatus 5 as long as the apparatus 5 can be identified. The sequence name is a name including an apparatus name and an operation name that indicates an operation of the apparatus 5. It can be said that the sequence name indicates the operation of the apparatus 5 by including the operation name. In a case where the input form F is formed in a sheet of spreadsheet software, the storage section F1 is configured, for example, as a drop-down list. The storage section F1 is provided so as to be viewable in the apparatus collation information creation area F2 and the sequence information creation area F3, which will be described later.

The apparatus collation information creation area F2 is provided for creating the apparatus collation information. The apparatus collation information is information in which a correspondence relation between an apparatus name and a device is defined in advance. The apparatus collation information creation area F2 includes, in one unit, for example, a device entry area F21 in which a device is to be entered, and an apparatus name entry area F22 in which an apparatus name is to be entered. The device and the apparatus name entered in the device entry area F21 and the apparatus name entry area F22 that are in one row, respectively, are associated with each other. The apparatus collation information creation area F2 is configured so that the apparatus name can be acquired from the storage section F1.

The device is composed of a combination of a device symbol and a device number. The device name expresses, for example, an input relay as X, an output relay as Y, an internal relay as M, a timer as T, and a data register as D. Examples of devices include: bit devices (X, Y, M, and the like) that handle bit data (0, 1); word devices (D and the like) that handle numerical values; and mixed devices (T and the like) that handle bit data and word data. The device symbols may vary depending on a manufacturer of the PLC 4.

The sequence information creation area F3 is provided for entering sequence information. The sequence information is information in which sequence names are described in the operation order of the apparatus(es) 5. The sequence information creation area F3 has, for example, a name entry area F31 and a number description area F32 as illustrated in FIG. 2. The name entry area F31 is configured so that a sequence name as the compound name is entered per row. The number description area F32 is configured such that a sequence number which defines the operation order (sequence order) of the apparatus 5 is written per row. The sequence information creation area F3 is configured to be capable of acquiring the sequence name from the storage section F1.

In order to create the design information, the information creating section 11 has an apparatus collation information creating section 111 and a sequence information creating section 112.

In order to create the apparatus collation information with use of the input form F, the apparatus collation information creating section 111 has an acquisition section 111a and a creation section 111b. The acquisition section 111a acquires the apparatus name from the storage section F1 of the input form F in response to an operation made by a user, and enters the apparatus name in the apparatus name entry area F22. The creation section 111b associates the apparatus name that has been acquired by the acquisition section 111a with the device that has been entered in the device entry area F21.

In order to create the sequence information with use of the input form F, the sequence information creating section 112 has an acquisition section 112a and a creation section 112b. The acquisition section 112a acquires the sequence from the storage section F1 of the input form F, in response to an operation made by a user. The creation section 112b creates the sequence information by receiving an operation made by a user, in which the sequence names acquired by the acquisition section 112a are arranged in the operation order of the apparatus(es) 5. Although in FIG. 1, for convenience, the input form F stored in the storage device 12 is illustrated to include only the apparatus name and the sequence information, it is obvious that the input form F as illustrated in FIG. 2 is stored in the storage device 12.

### Creation of Design Information by PC 1

The following description will discuss creation of design information (method for creating information) by PC 1. First, the following will describe creation of apparatus collation information by PC 1.

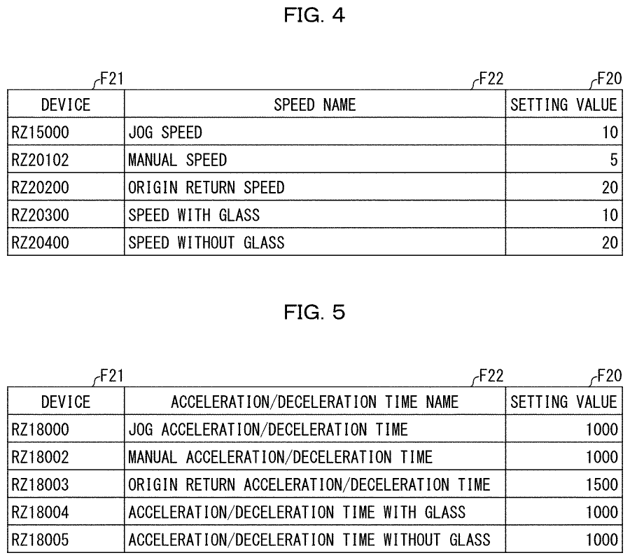

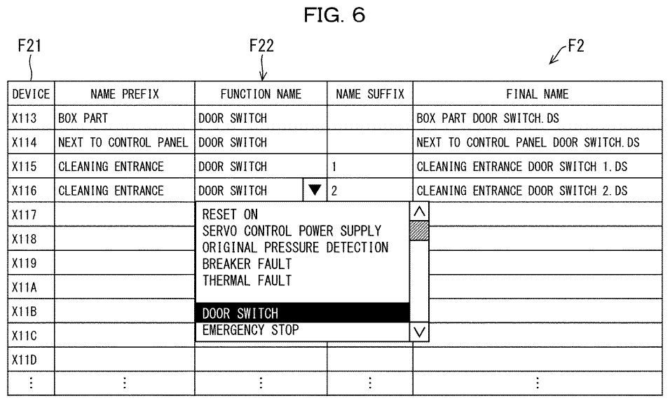

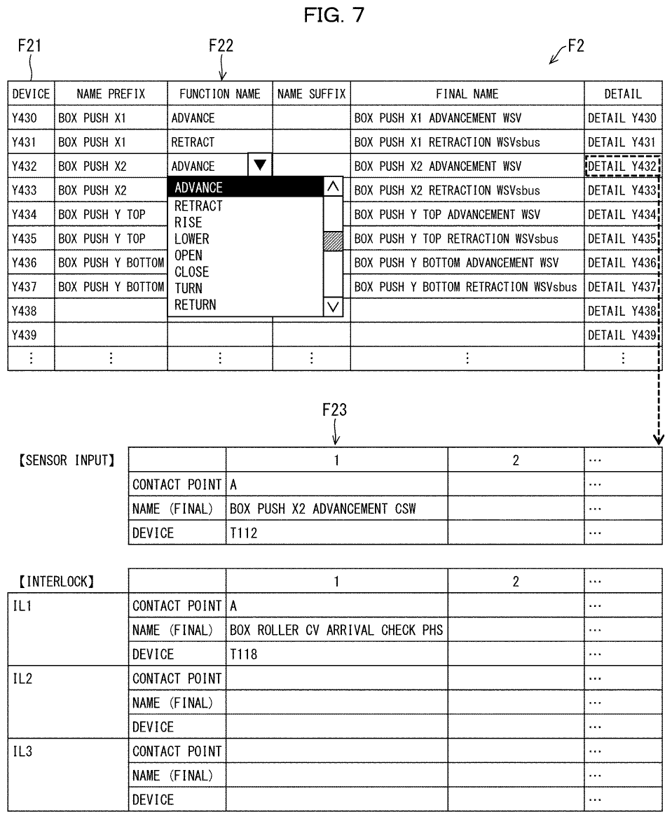

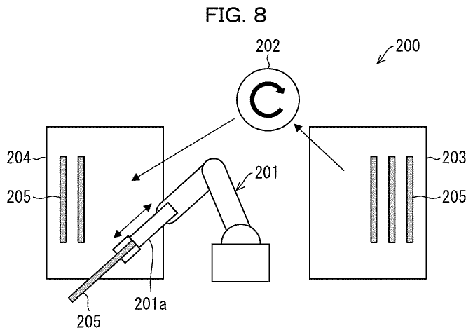

FIG. 3 is a diagram showing a part of the input form F in which apparatus collation information on positions of servomotors in design information is written. FIG. 4 is a diagram showing a part of the input form F in which apparatus collation information on speeds of servomotors in the design information is written. FIG. 5 is a diagram showing a part of the input form F in which apparatus collation information on acceleration/deceleration times of servomotors in the design information is written. FIG. 6 is a diagram showing a part of the input form F in which apparatus collation information on an input apparatus(es) in the design information is written. FIG. 7 is a diagram showing a part of the input form F in which apparatus collation information on output apparatuses in the design information is written. FIG. 8 is a diagram illustrating a configuration of a re-packer 200 for which sequence information in the design information is to be created.

With regard to creation of the apparatus collation information, the following will describe an example in which the apparatus collation information related to the apparatus 5 in the re-packer that is configured as below is created by the PC 1.

As illustrated in FIG. 8, the re-packer 200 includes a robot arm 201, a turning device 202, a box 203 made of expanded polystyrene, and a box 204 that is disposed at a different position from the box 203. The robot arm 201 has an arm part 201a. The arm part 201a is configured to be extendable and retractable in a direction of an arrow by a servomotor. The robot arm 201 takes out a glass 205 from the box 203 and carries the glass to a pivoting device 202. Further, the turning device 202 chucks, at four corners of the glass 205, the glass 205 that has been taken out, and turns by 90°. Then, the robot arm 201 loads, in the box 204, the glass 205 which has been turned. The robot arm 201 and the turning device 202 each include a servomotor as a driving source. The re-packer 200 is provided with various sensors for position detection and the like.

Further, the re-packer 200 is provided in a sealed chamber having a plurality of doors. The doors are each provided with a switch that turns on when the door is opened. Further, the re-packer is provided with a switch for an emergency stop. Further, the re-packer is provided with an operation panel for monitoring and making an operation, a push-button switch, a lamp, and the like.

The apparatus collation information creating section 111 first sets an axis name and sets details on each axis, for the servomotor. For example, the axis name of the servomotor which is used for extending and retracting the robot arm 201 is referred to as “arm Z”. Further, the axis name of the servomotor used in the turning device 202 is referred to as “glass turn”. As illustrated in FIGS. 3 to 5, the apparatus collation information creating section 111 creates the apparatus collation information on position, speed, and acceleration/deceleration times, for the axis name “arm Z”.

As illustrated in FIG. 3, the acquisition section 111a acquires, regarding the position of the arm Z, a position name as the apparatus name. The acquisition section 111a acquires, from the storage section F1 of the input form F, this position name according to an operation made by a user (e.g., a selecting operation in a drop-down list). Then, the acquisition section 111a enters the position name in the apparatus name entry area F22. As the position name, for example, “minimum movement amount”, “maximum movement amount”, “retraction position”, “chuck position (before turning)” and “chuck position (after turning)” are acquired. Further, the acquisition section 111a also acquires, from the storage section F1, respective setting values of the “minimum movement amount”, the “maximum movement amount”, the “retraction position”, the “chuck position (before turning)”, and the “chuck position (after turning)” according to the operation made by the user. The acquisition section 111a then enters the setting values in the setting value entry area F20.

The creation section 111b associates the following with each other: the position name acquired by the acquisition section 111a; the device that is entered in the device entry area F21; and the setting value that is entered in the setting value entry area F20. Entry of the device may be inputting devices one by one by a user. Alternatively, entry of the device may be entry of a device number by a user for a first apparatus name, and the creation section 111b may add one device number at a time for subsequent apparatus names and thus generate consecutive devices.

As illustrated in FIG. 4, the apparatus collation information creating section 111 creates the apparatus collation information also for the speed, in the same manner as in the case of the position. Further, as illustrated in FIG. 5, the apparatus collation information creating section 111 creates the apparatus collation information also for the acceleration/deceleration times in the same manner as in the case of the position.

As illustrated in FIG. 6, with regard to the input apparatus, in the apparatus name entry area F22 of the apparatus collation information creation area F2, “name prefix”, “function name”, “name suffix” and “final name” are provided. The “function name” is a part that indicates the function of the input apparatus. The “function name” may be a name of the input apparatus, like a “door switch”, that indicates the function. A plurality of “function names” are prepared in advance so as to be selectable in a drop-down list. The “name prefix” is a part to be added preceding the “function name” and indicates, for example, a place where the input apparatus is to be placed. The “name suffix” is a part to be added subsequent to the “function name”. The “final name” is an apparatus name that is constituted by adding the “prefix name” preceding the “function name” and further adding the “name suffix” subsequent to the “function name”.

The acquisition section 111a acquires, from the storage section F1 of the input form F, the “name prefix”, the “function name” and the “name suffix” according to an operation made by a user (e.g., a selecting operation in a drop-down list). Then, the acquisition section 111a determines the “final name” by combining these names. The “name prefix” and “name suffix” may be entered by input made by a user.

The creation section 111b associates the final name that has been determined by the acquisition section 111a with the device that has been entered in the device entry area F21. Entry of the device is made according to the same procedure as entry of a device in creation of the apparatus collation information of the servomotor described above.

As illustrated in FIG. 7, also with regard to the output apparatus, in the apparatus name entry area F22 of the apparatus collation information creation area F2, “name prefix”, “function name”, “name suffix” and “final name” are provided. Here, the “name prefix” may be a name of the output apparatus.

For example, “BOX PUSH X2”, which is written as the “name prefix” in FIG. 7, indicates an air cylinder. The air cylinder has ports for air supply and air exhaust on a head side and a rod side, respectively. The air cylinder advances and retracts a rod by switching between air supply and air exhaust to and from the ports with use of an electromagnetic valve (WSV: double solenoid valve). In FIG. 7, advancement of the rod of the air cylinder referred to as “BOX PUSH X2” for the device “Y432” is indicated by the “final name”.

Further, unlike the apparatus collation information creation area F2 for the input apparatus, the apparatus collation information creation area F2 for the output apparatus is provided with “detail”. The “detail” is provided for setting interlock and sensor input that corresponds to the output apparatus. In the “detail”, a name, a contact point (contact type), and a device can be set. Further, for example, in a case where the input form F is formed in a sheet of spreadsheet software, a link for jumping to the detail entry area F23 that is provided in a sheet separate from that of the apparatus collation information creation area F2 is written in the “detail”.

In the “sensor input” of the detail entry area F23, for example, a sensor for detecting that the rod of the air cylinder has arrived at an advancement position is written. Specifically, “BOX PUSH X2 ADVANCEMENT CSW” is written as a name of the sensor, and “T112” is written as the device. The name of the sensor may be selected from the drop-down list of the apparatus name entry area F22 in the apparatus collation information creation area F2 illustrated in FIG. 6.

The acquisition section 111a determines the “final name” in the same manner as in the case where the “final name” of the input apparatus is determined. The creation section 111b associates the final name with the device in the same manner as in the case where the “final name” of the input apparatus is determined. Further, the creation section 111b creates the “detail” on the basis of an input operation of a user.

Next, the following will describe creation of sequence information by the PC 1.

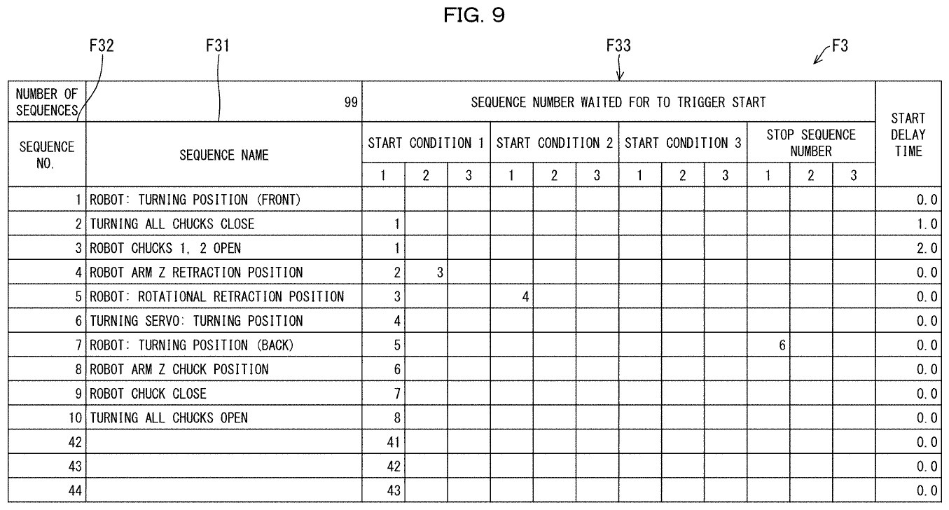

FIG. 9 is a diagram showing a part of an input form F in which sequence information on the re-packer 200 is written. FIG. 9 shows a sequence information creation area F3 in the input form F that has been formed as a sheet of spreadsheet software.

Regarding creation of the sequence information, the following will describe an example in which sequence information for the apparatus 5 in the re-packer that is configured as follows is created by the PC 1.

The sequence information creating section 112 creates the sequence information in the sequence information creation area F3 shown in FIG. 9. The sequence information creation area F3 has the name entry area F31 and the number entry area F32 which are described above, and a condition entry area F33. The condition writing area F33 is provided to enter a condition for starting the operation of the apparatus 5 that is defined by the sequence name.

Although not illustrated, the sequence information creation area F3, like the apparatus collation information creation area F2, is provided with “detail”. In the “detail”, a link to a sheet that sets a detail regarding the sequence name is written. Further, the “detail” is provided for setting the output apparatus such as an electromagnetic valve or for setting the servomotor. In the case of output apparatuses, for example, the name (sequence name), contact point (contact type), and device of each of the output apparatus can be set in the “detail”. In the case of servomotors, for example, the axis name (sequence name), contact point (contact type), and device of each of the servomotors can be set in the “detail”.

The acquisition section 112a of the sequence information creating section 112 acquires the sequence name from the storage section F1 of the input form F according to an operation made by a user, for example, a selecting operation in a drop-down list. The acquisition section 112a then enters the sequence name in the sequence information creation area F3 (acquisition step). FIG. 9 shows an example in which “robot: turning position (front)” is written in the name entry area F31. Regarding the “robot: turning position (front)”, the “robot” indicates the apparatus name of the robot arm 201, and the “turning position (front)” indicates an operation name of an operation in which the robot arm 201 moves the glass 205 to the position before turning of the turning device 202. The creation section 111b creates the sequence information by receiving the above-described selecting operation made by the user in which sequence names are arranged in the order of sequence numbers.

Further, the creation section 112b sets, on the basis of the condition entered in the condition writing area F33, the operation order of the apparatus 5 that is defined by the sequence name (creation step). For example, in the sequence information creation area F3 shown in FIG. 9, the following areas are provided: three start condition entry areas in which the start condition is entered; an area in which the sequence number for stopping the operation is entered; and an entry area of “start delay time” for which the start of the operation is to be delayed. Each of such start condition entry areas is provided with an area in which three sequence numbers can be entered. When any of the operations of the sequence numbers entered in the three start condition entry areas is completed (OR condition), the operation is started.

In the example illustrated in FIG. 9, operations of sequence numbers (2) and (3) start when an operation of sequence number (1) ends. However, the operation of the sequence number (2) starts one second (which has been set as the start delay time) after the operation of the sequence number (1) ends. Further, the operation of the sequence number (3) starts two seconds after the operation of the sequence number (1) ends. An operation of sequence number (4) starts when the operations of the sequence numbers (2) and (3) end. An operation of sequence number (5) starts when the operation of the sequence number (3) or (4) ends.

An operation of sequence number (6) starts when the operation of the sequence number (4) ends. An operation of sequence number (7) starts when the operation of the sequence number (5) ends, but the operation of the sequence number (6) is stopped at the same time as the operation of the sequence number (5) starts. Respective operations of the sequence numbers (8) to (10) start when the operations of the sequence numbers (6) to (8) ends, respectively.

When the information creating section 11 has created the apparatus collation information and the sequence information as described above, the information creating section 11 transmits, to the PC 2 via the communication section 15, design information that includes the apparatus collation information and the sequence information.

### (Configuration of PC 2)

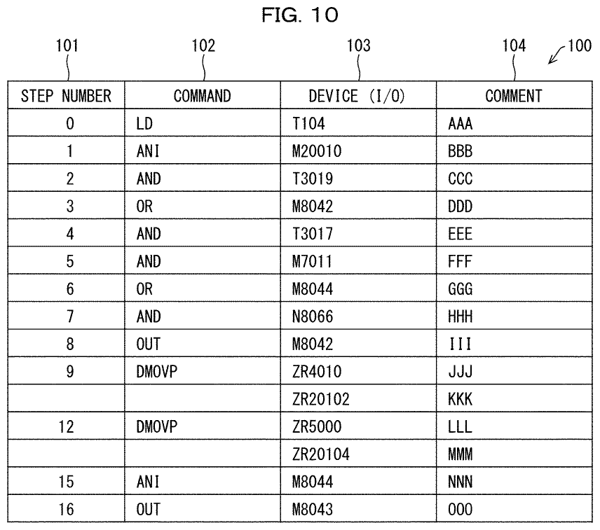

First, the following will describe the command list 100 described above. FIG. 10 is a diagram showing a command list 100 that is created by the PC 2.

As shown in FIG. 10, the command list 100 has a step number description area 101, a command description area 102, a device description area 103, and a comment description area 104.

In the step number description area 101, a step number that defines the order in which the command is to be executed is written. In the command description area 102, a command represented by a format (command symbol) such as a mnemonic is written. In the device description area 103, a device is written. In the comment description area 104, the sequence name described above is written as a comment to be attached to the ladder program. The command list 100 is in a tabular format, and the step number, command, device, and comments written in each row are associated with each other.

The PC 2 is configured as a command list creating device for creating the command list 100. In order to create the command list 100, the PC 2 includes a command list generation section 21, a storage device 22, an input device 23, a display device 24, and a communication section 25. The input device 23 is a device through which a user makes an operation such as making instruction to create the command list 100 and/or instruction to export, to the PC 3, the command list 100. The display device 24 displays a screen for receiving the above operation(s).

In the storage device 22, the apparatus collation information and the sequence information of the design information that has been transmitted via the communication section 15 of the PC 1 and received by the communication section 25 are stored. Further, in the storage device 22, the command list 100 that was generated by the generation section 211 is stored. Further, in the storage device 22, command collation information is stored.

The command collation information is information in which a correspondence relation between a sequence name and a command represented by the mnemonic format described above is defined in advance. Further, the command collation information defines in advance a correspondence relation between the sequence name and a related command that is related to the command corresponding to the sequence name.

Examples of the related command include commands for, for example, fault detection and completion confirmation, which are carried out on the basis of the sensor input entered in the detail entry area F23 shown in FIG. 7. Further, the related command is a permission command that permits execution of a next command in a case where a specific condition is satisfied. The related command may include a command related to interlock that is entered in the detail entry area F23.

The command list generation section 21 has a generation section 211 and an export section 212. The export section 212 exports, to PC 3, the command list 100 that was generated by the generation section 211. The export section 212 converts the command list 100 into the CSV format and exports the command list 100.

The generation section 211 associates the above-described command including the related command with a device, and generates the command list 100. Further, the generation section 211 associates, with the command, the sequence name as the comment described above in the command list 100. In order to generate the command list 100, the generation section 211 has a command identifying section 211a and a device identifying section 211b (identification information identifying section).

The command identifying section 211a refers to the command collation information, and identifies the command corresponding to the sequence name that was sequentially read out from the sequence information. Further, the command identifying section 211a identifies the related command corresponding to the sequence name that was sequentially read out from the sequence information.

The device identifying section 211b refers to the apparatus collation information, and identifies a device corresponding to the apparatus name that is included in the sequence name read out.

### (Creation of Command List 100 by PC 2)

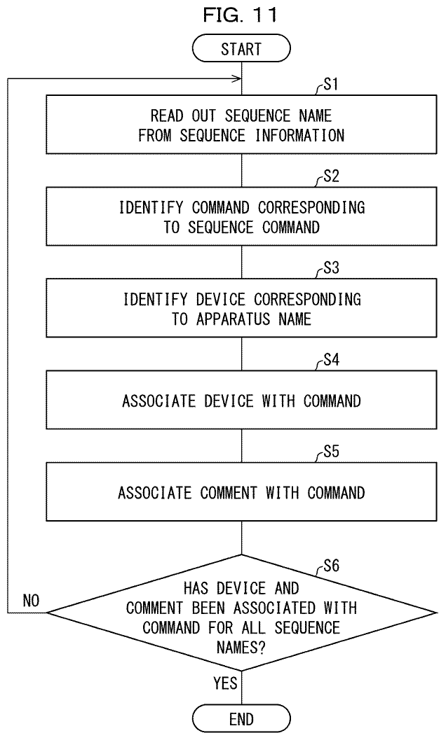

The following will describe creation of the command list 100 (command list creation method) by the PC 2. FIG. 11 is a flowchart showing a procedure of creation of the command list by the PC 2.

As illustrated in FIG. 11, first, the command identifying section 211a and the device identifying section 211b of the generation section 211 read out the sequence name from the sequence information stored in the storage device 22, in the operation order of the apparatus 5 (step S1). Specifically, the command identifying section 211a and the device identifying section 211b read out the sequence name from the sequence information that are stored in the storage device 22. Next, the command identifying section 211a identifies, with reference to the command collation information stored in the storage device 22, the command corresponding to the sequence name (step S2, command identifying step).

The device identifying section 211b refers to the apparatus collation information that is stored in the storage device 22, and identifies the device corresponding to the apparatus name included in the sequence name read out (step S3, identification information identifying step). Note that step S2 and step S3 may be reversed in order or may be carried out at the same time. The generation section 211 associates the device identified by the device identifying section 211b with the command identified by the command identifying section 211a (step S4, generation step). Further, the generation section 211 associates, as a comment with the command, the sequence name read out (step S5). Note that step S4 and step S5 may be reversed in order or may be carried out at the same time.

The generation section 211 then determines whether or not the device has been associated with the command for all of sequence names (step S6). When it is determined in step S6 that the device has been associated with the command for all of the sequence names (YES), the generation section 211 ends a process for creating the command list 100. When it is determined in step S6 that the device has not been associated with the command for all the sequence names (NO), the generation section 211 returns the process to step S1.

In this way, the PC 2 creates the command list 100 on the basis of: the apparatus collation information created by the apparatus collation information creating section 111 of the PC 1; and the sequence information created by the sequence information creating section 112 of the PC 1. In the command list 100, a comment in accordance with a ladder program is described. For example, regarding a ladder program related to a fault circuit, in a case where the fault circuit includes a glass detection sensor, a comment like “fault in detection by glass detection sensor” is automatically described.

The generation section 211 stores, in the storage device 22, the command list 100 thus created. Further, the export section 212 of the generation section 211 reads out the command list 100 that is stored in the storage device 22, in response to an instruction from a user. The export section 212 then converts the command list 100 into the CSV format and causes the communication section 25 to transmit the command list 100 to the PC 3, and thus exports the command list 100. Note that depending on the PC 3 (ladder program creating device) described later to which the command list 100 is exported, the command list 100 that was converted in a format other than the CSV format may be used. Therefore, the format into which the command list 100 is converted by the export section 212 is not limited to the CSV format.

### Configuration of PC 3

The PC 3 is configured as a ladder program creating device for creating a ladder program. In order to create a ladder program, the PC 3 includes a ladder program creating section 31, a storage device 32, an input device 33, a display device 34, and a communication section 35. The input device 33 receives an operation such as making instruction to create the ladder program from a user and instruction to write, into the PLC 4, the ladder program thus created. The display device 34 displays a screen for receiving the operation.

The ladder program creating section 31 is realized by commercially available ladder program creation software. In order to create the ladder program, the ladder program creating section 31 has an import section 311, an automatic generation section 312, a conversion section 313, and a writing section 314.

The import section 311 imports the command list 100 in the CSV format which has been exported from the PC 2. The automatic generation section 312 analyzes, in step number order, the command described in the command list 100. The automatic generation section 312 converts the command into a ladder symbol that constitutes a ladder program (ladder diagram) and arranges the ladder symbol in the ladder diagram, thereby automatically generating the ladder program. The automatic generation section 312 stores, in the storage device 32, the ladder program generated.

The conversion section 313 reads out, from the storage device 32, the ladder program generated by the automatic generation section 312, and converts (compiles) the ladder program into a format (code) recognizable by the control section 43 (CPU) of the PLC 4. The conversion section 313 stores the converted code in the storage device 32. The writing section 314 writes, in the program memory 42 of the PLC 4 via the communication section 25, the code that has been converted from the ladder program by the conversion section 313.

### Creation of Ladder Program by PC 3

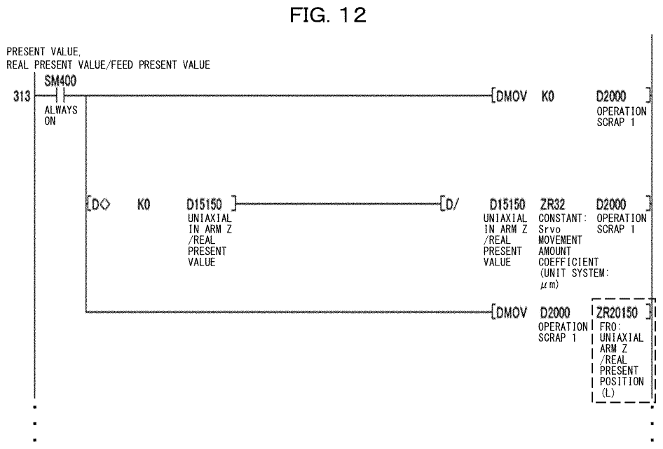

FIGS. 12 to 23 are diagrams showing various ladder programs that were created by the PC 3.

The PC 3 creates a ladder program with the configuration as described above. The following will describe various ladder programs.

The ladder program illustrated in FIG. 12 represents a process of acquiring and outputting a present value from a servomotor, as shown by a broken line frame. In this case, the device and the comment added are described by a ladder program creating section 31 (automatic generation section 312) of the PC 3, on the basis of the device and the comment described in the command list 100, respectively. This applies to the ladder programs described below.

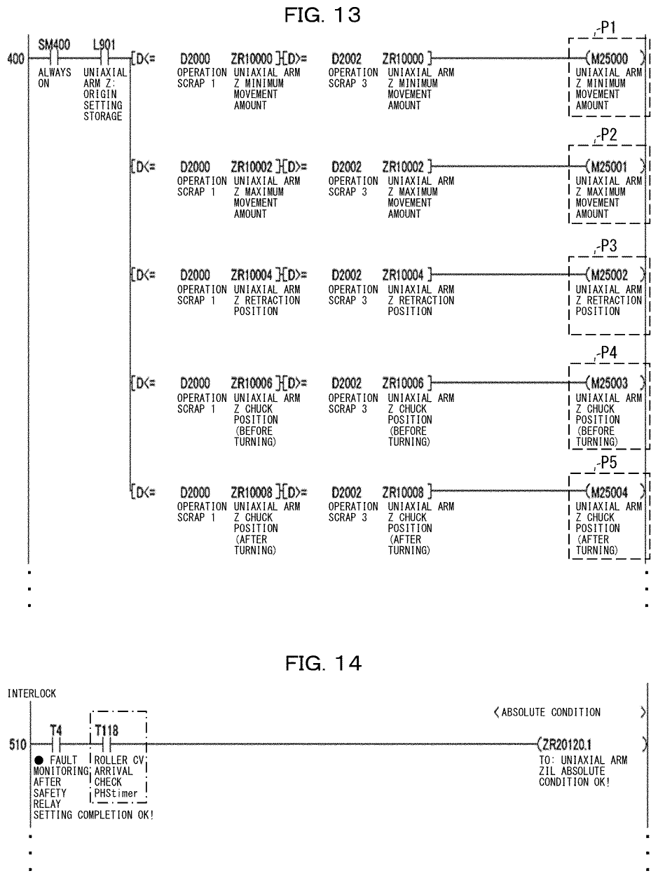

The ladder program illustrated in FIG. 13 represents a process of outputting positions of a servomotor. Each of the positions is based on the apparatus collation information illustrated in FIG. 3. When the output signal is turned ON, respective present positions P1 to P5 of the servomotor can be found for the “minimum movement amount”, the “maximum movement amount”, the “retraction position”, the “chuck position (before turning)”, and the “chuck position (after turning)”. Although not illustrated, also for the speed illustrated in FIG. 4 and the acceleration/deceleration times illustrated in FIG. 5, a corresponding ladder program is created.

The ladder program illustrated in FIG. 14 represents a process of interlocking, as indicated by a broken line frame. The interlocking is based on a setting in the detail entry area F23 illustrated in FIG. 7. In the example illustrated in FIG. 14, it is defined that unless a sensor of a device “T118” is turned “ON”, the interlocking is not put into operation.

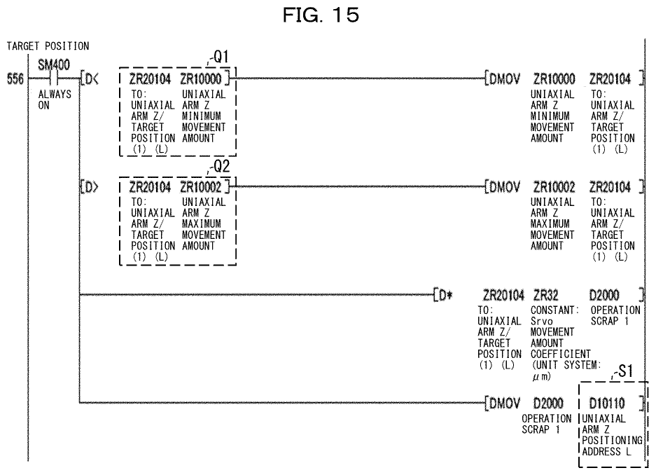

The ladder program illustrated in FIG. 15 represents a process of carrying out setting S1 of a target position. The target position and a movement amount are based on a setting of the apparatus collation information. This movement amount is limited so as not to be equal to or less than the minimum movement amount Q1 or equal to or more than the maximum movement amount Q2 in FIG. 3.

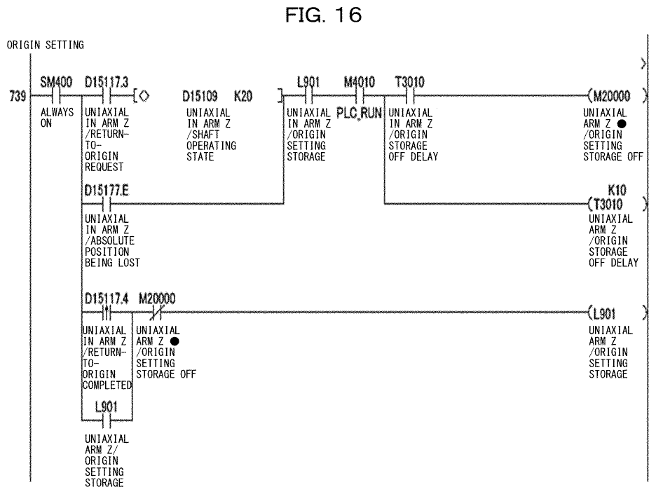

The ladder program illustrated in FIG. 16 represents a process of setting an origin of a servomotor. The setting of the origin is based on the setting of the apparatus collation information. The servomotor has an encoder. The present position can be found by an output value of the encoder. With the process of the ladder program, whether or not a zero point (origin) of the servomotor is registered is checked. In a case where the zero point is not registered, a “fault message” is outputted and no operation can be carried out. For this reason, when a “fault message” is received, the origin is set.

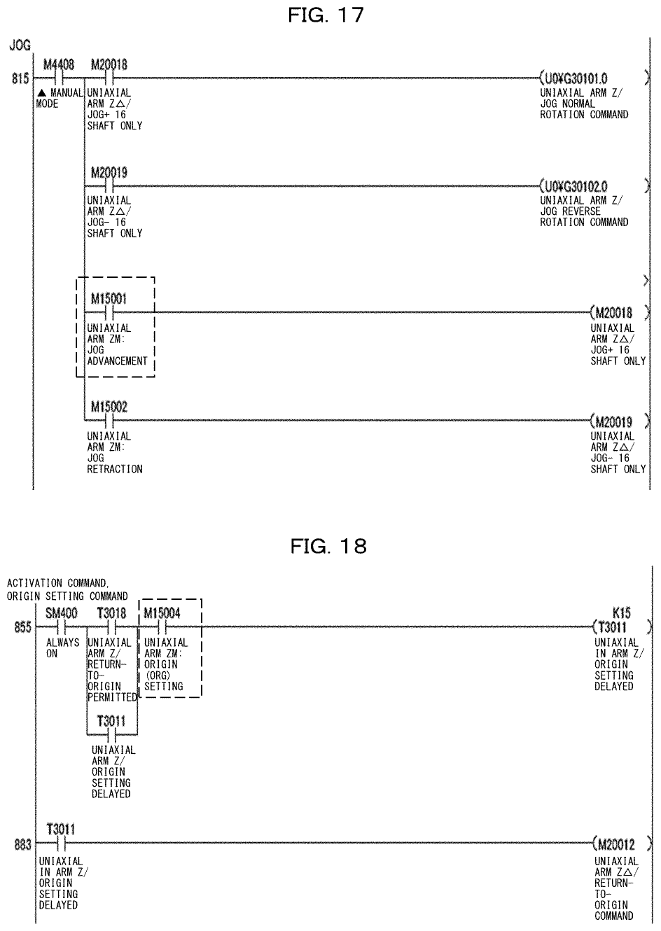

The ladder program illustrated in FIG. 17 represents a process of carrying out JOG activation of a servomotor. The JOG activation is based on the setting of the apparatus collation information. As shown by a broken line frame, an internal relay of a device “M15001” turns ON when an operation button is pressed. This causes a JOG command for carrying out JOG operation to be issued to the servomotor.

The ladder program illustrated in FIG. 18 represents a process of giving an activation command to a servomotor. The activation command to the servomotor is based on the setting of the apparatus collation information. As shown by a broken line frame, an internal relay of a device “M15004” turns ON when an operation button is pressed. This causes an activation command to set the origin to be issued to the servomotor.

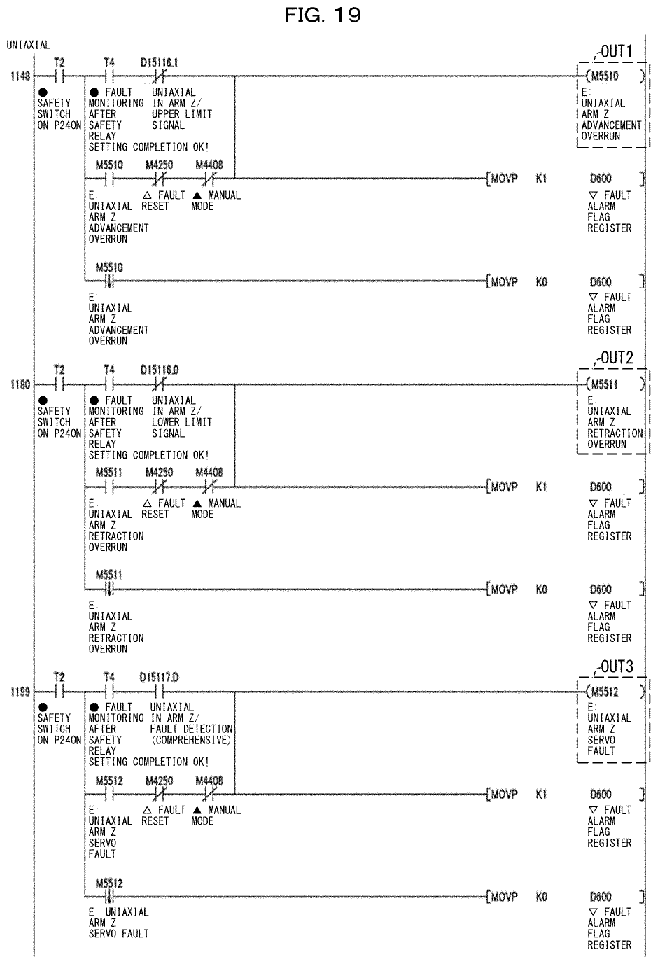

The ladder program illustrated in FIG. 19 represents a process at the time when a fault occurs. The process at the time when a fault occurs is based on the setting of the apparatus collation information. Normally, a servomotor has a function of detecting an overrun. The overrun is based on the setting of the apparatus collation information. In a case where arrival at an advancement end is detected as a fault, an internal relay of a device “M5510” is turned ON in output OUT1. On the other hand, in a case where arrival at a retraction end is detected as a fault, the internal relay of the device “M5511” is turned ON at output OUT2. Further, in a case where issue of some fault by the servomotor is detected as a fault, an internal relay of a device “M5512” is turned ON in output OUT3.

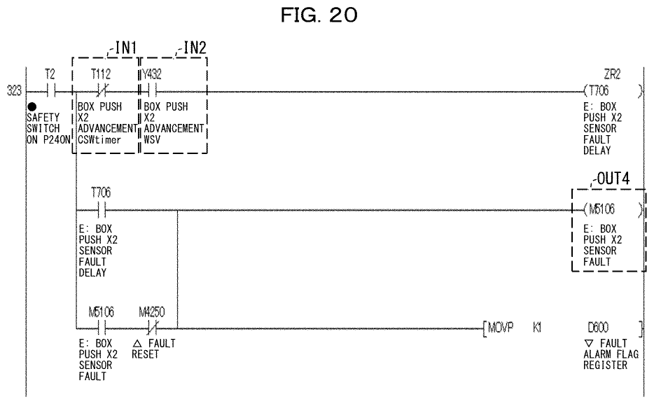

The ladder program illustrated in FIG. 20 represents a process of detecting a fault by a sensor. The process of fault detection is based on the setting of the apparatus collation information. Although an advancement command is issued with respect to the air cylinder called “BOX PUSH X2” (see FIG. 7) described above, a sensor that detects an advancement position of the rod may not be turned ON. In this case, a sensor of the device “T112” is turned OFF at an input IN2 although an input relay of the device “Y432” is turned ON at an input IN1, as indicated by a broken line frame by the ladder program. Therefore, in this case, in output OUT4, an internal relay of a device “M5106” is turned ON in order to give a notification on a fault.

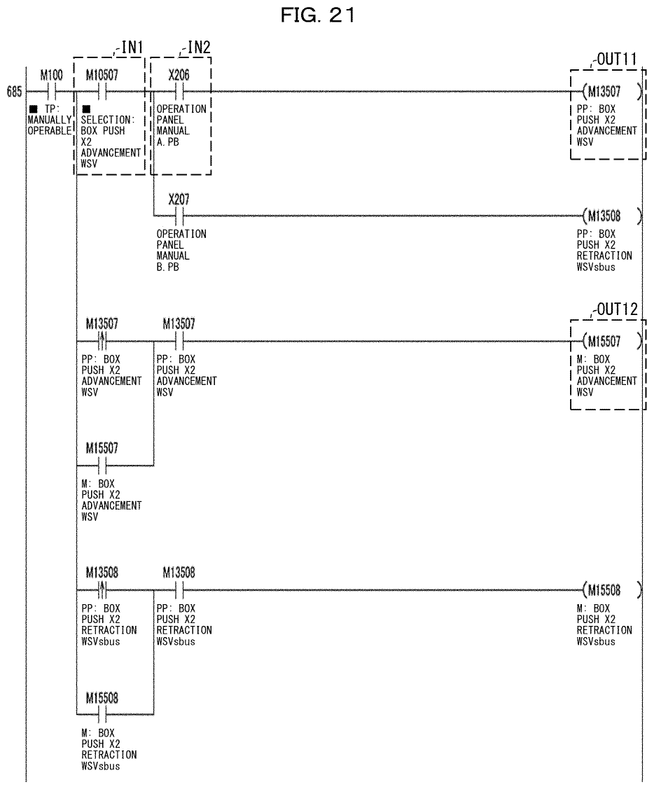

The ladder program illustrated in FIG. 21 represents a process of in which a manual operation is carried out. The process of the manual operation is based on the setting of the apparatus collation information. For example, in a case where an operation button on a screen displayed on the operation display device 7 (see FIG. 24), which will be described later, is operated by an operator, an internal relay of a device “M10507” is turned ON at an input IN11. Further, in a case where a mechanical operation button is operated by an operator, an input relay of a device “X206” is turned ON at an input IN12. Accordingly, when an internal relay of a device “M13507” is turned ON at an output OUT11, an internal relay of a device “M15507” is eventually turned ON at an output OUT12.

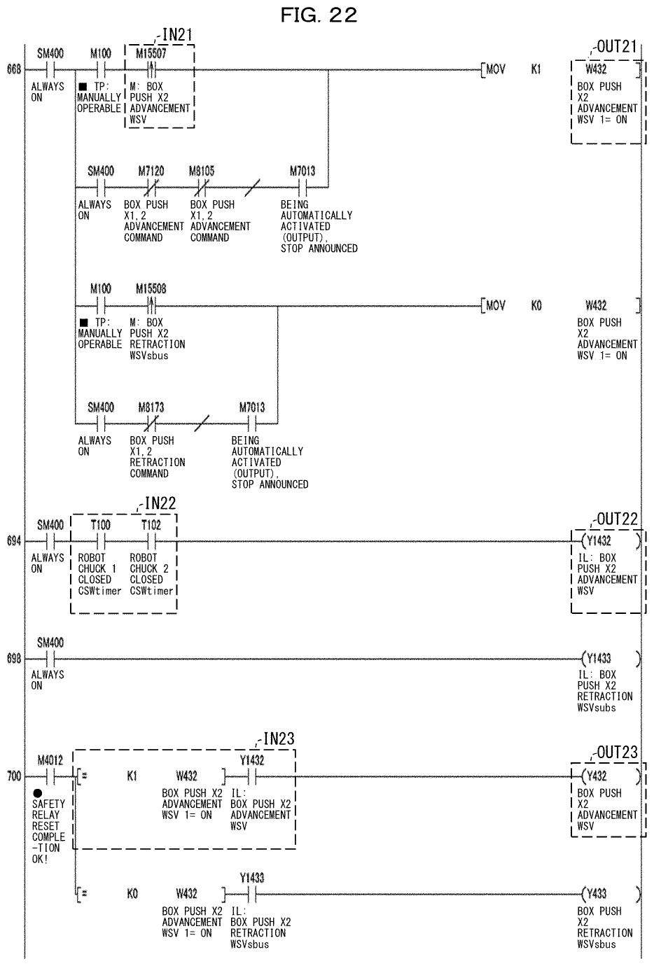

The ladder program illustrated in FIG. 22 represents a process of carrying out an operation of an output circuit. The operation of the output circuit is based on the setting of the apparatus collation information. In the step number 668, in a case where the internal relay of the device “10507” is turned ON at an input IN21 by the above-described manual operation, “1” is written in a link register of a device “W432” at an output OUT21. In the step number 694, in a case where timer bits of a device “T100” and a device “T102” that constitute interlock at an input IN22 turn ON, an output relay of a device “Y1432” is turned ON at an output OUT22. Further, in the step number 700, in a case where the value of the link register of the device “W432” is “1” at an input IN23 and the output relay of the device “Y1432” is turned ON, the output relay of the device “Y432” is turned ON at the output OUT23. Thus, the rod of the air cylinder described above advances.

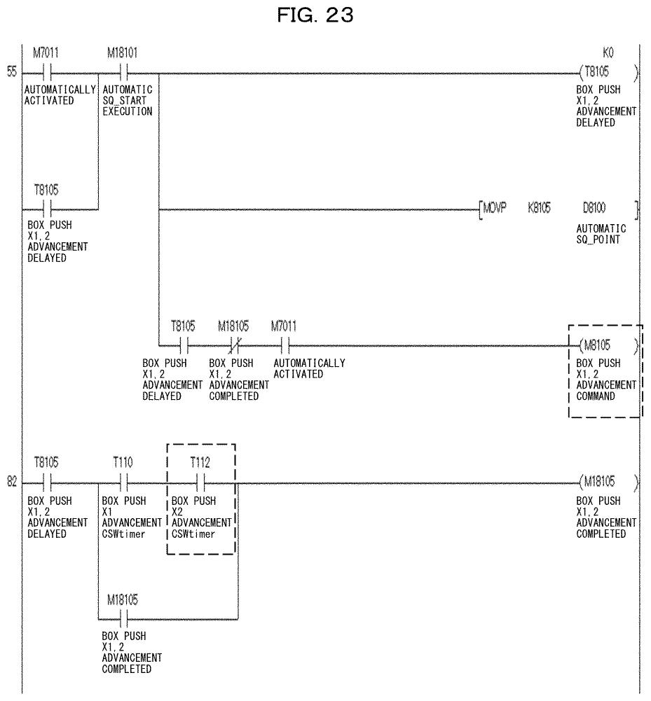

The ladder program illustrated in FIG. 23 shows a process of carrying out an automatic operation. The automatic operation is based on the setting of the apparatus collation information. In the step number 55, when an internal relay of a device “M8105” related to an execution command of the automatic operation is turned ON, the automatic operation is activated in the step number 668 of the ladder program illustrated in FIG. 22. Accordingly, “1” is written in the link register of the device “W432” and the output relay of the device “Y432” is turned ON, so that the rod of the air cylinder advances. As a result, when the sensor of the device “T112” is turned ON in the step number 82 of the ladder program illustrated in FIG. 23, the advancement movement of the rod of the air cylinder is completed.

In addition, the PC 3 creates various ladder programs of, for example, a command to activate a servomotor, confirmation that the servomotor has arrived at a target position, confirmation that a power of the servomotor is ON, and stopping a shaft in a case where the servomotor is not to be moved, although details of the various ladder programs are omitted here.

### Effects

The ladder program creating system 1001 of the present embodiment includes a PC 2 having a command list generation section 21. The command list generation section 21 has a generation section 211 that includes a command identifying section 211a and a device identifying section 211b.

In the above configuration, the command identifying section 211a refers to the command collation information, and the device identifying section 211b refers to the apparatus collation information. Accordingly, a command corresponding to the sequence name that has been sequentially read out from the sequence information and a device corresponding to the apparatus name included in the sequence name are identified. Therefore, the command and the device are associated with each other, and are described in the order in which the sequence name is read out. Thus, in the command list 100, the command is written in the order of execution, and the command list 100 in which the device is associated with each command is created. This makes it possible to automatically create the command list 100 from the sequence information.

The command collation information defines in advance the correspondence relation between the sequence name and a related command that is related to the command corresponding to the sequence name. The command identifying section 211a identifies a related command corresponding to the sequence name that was sequentially read out from the sequence information. Further, the generation section 211 associates the related command with the device in the command list 100.

With the above-described configuration, it is possible to create a command list such that the command list includes not only a command which constitutes a main sequence but also a related command which is related to the command.

The related command may be a permission command that permits execution of a next command, in a case where a specific condition is satisfied. This makes it possible to define interlock on the basis of the permission command.

The generation section 211 may associate the sequence name with the command in the command list 100. This makes it possible to use the sequence name as a comment in a sequence program when the sequence program such as a ladder program is automatically generated on the basis of the command list 100.

Further, the ladder program creating system 1001 includes a PC 3 that has a sequence information creating section 112. Accordingly, the sequence information is created on the basis of the sequence name that has been prepared in advance in the storage section F1 of the input form F. This makes it possible to efficiently create the sequence information.

Note that in the present embodiment, a ladder program is created by the PC 3 on the basis of the command list 100 that has been created by the PC 2. However, in a case where the PLC 4 can recognize the command list 100, the command list 100 may be directly written in the PLC 4 as a sequence program.

### Embodiment 2

The following description will discuss another embodiment of the present invention. Note that for convenience of explanation, members having functions identical to those of respective members described in the foregoing embodiment are given respective identical reference numerals, and descriptions of those members will not be repeated.

### Overview of Screen Creating System 1002

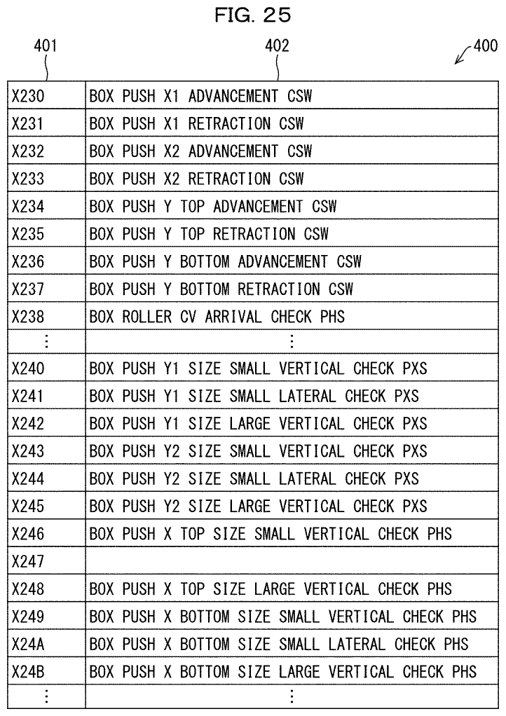

FIG. 24 is a block diagram illustrating a configuration of a screen creating system 1002 in accordance with Embodiment 2. FIG. 25 is a diagram showing a device list 400.

As illustrated in FIG. 24, the screen creating system 1002 includes a PC 1 and a PC 2 in the same manner as the ladder program creating system 1001, and includes a PC 6 differently from the ladder program creating system 1001. The PC 6 is a personal computer, like the PCs 1 and 2.

The screen creating system 1002 creates design information, creates a command list 100 on the basis of the design information, and automatically creates screen data on the basis of the device list 400 obtained from the command list 100. The screen data allows the operation display device 7 to display a screen. The screen data created is downloaded to the operation display device 7.

The operation display device 7, which is also called a programmable display device or the like, is connected to a PLC 4 via a communication cable, and thus communicates with the PLC 4. The operation display device 7 is a dedicated computer that is configured as a human machine interface (HMI) apparatus which realizes, by displaying a screen for operation and display, an operation function and a display function specific to the operation display device 7. Specifically, the operation display device 7 carries out display or the like of, for example: an operation for giving a command to the PLC 4; and a state of an apparatus 5 based on data acquired from the PLC 4.

The screen is composed of various parts (objects) that are arranged on a base screen. As the parts, a name plate part for text display, a numerical indicator, a display system part such as a lamp, and an operation system part such as an operation button are used. In the display system part, there is a part that is associated with an address and that reflects a state of the data acquired from the PLC 4 regarding the address. In addition, in the operation system part, there is a part that is associated with an address and that gives data regarding the address to the PLC 4.

The operation display device 7 has a communication section 71, a screen memory 72, a control section 73, a touch panel 74, and a display device 75. The communication section 71 receives, from the PC 6, the screen data created by the PC 6, and communicates with the PLC 4. The screen memory 72 stores the screen data that has been received by the communication section 71. The control section 73 causes the display device 75 to display a screen on the basis of the screen data, and receives an operation to the touch panel 74 on the screen. Further, the control section 73 updates the display state of the screen in accordance with communication with the PLC 4.

The export section 212 of the PC 2 outputs, in the CSV format, a device list 400 obtained by deleting the step number and the naming from the command list 100, instead of the command list 100 described above. As shown in FIG. 25, the device list 400 has a device description area 401 and a comment description area 402.

### Configuration of PC 6

The PC 6 is configured as a screen creating device for creating screen data. In order to create the screen data, the PC 6 includes a screen creating section 61, a storage device 62, an input device 63, a display device 64, and a communication section 65. The input device 63 is a device that receives an operation made by a user, such as making an instruction to create screen data, an instruction to download, to the operation display device 7, the screen data created, and/or the like. The display device 64 displays a user interface screen for receiving the operation(s).

The screen creating section 61 has an import section 611, an association section 612, and a setting section 613 for creating the screen data. The screen creating section 61 stores, in the storage device 62, the screen data created, and causes the communication section 65 to transmit the screen data to the operation display device 7 in response to an instruction made by a user.

The import section 611 imports the device list 400 that was exported in the CSV format. The association section 612 uses a screen template as a template of screen data which corresponds to a ladder program to be created by the PC 3. In the screen template, various parts are arranged in advance in a configuration corresponding to production equipment in a base screen. The parts are associated with respective temporary addresses, and the screen template is stored in, for example, the storage device 62. Further, in the screen template, some of the parts may not be disposed.

The association section 612 replaces, with devices listed in the device list 400, the respective temporary addresses that are associated with the parts of the screen template. Further, the association section 612 disposes, for a screen template in which some of the parts are not disposed, a part corresponding to a device in the device list 400 at a predetermined position of the screen template. The association section 612 then associates the part with the device that corresponds to the part.

The setting section 613 sets a comment in the device list 400 for a corresponding part.

### Creation of Screen Data by PC 6

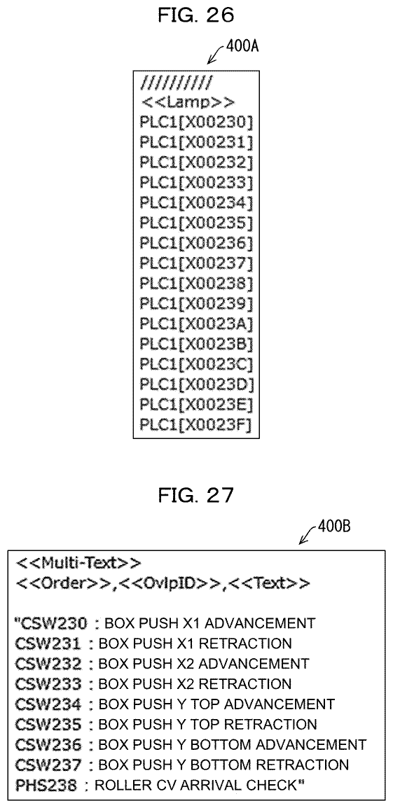

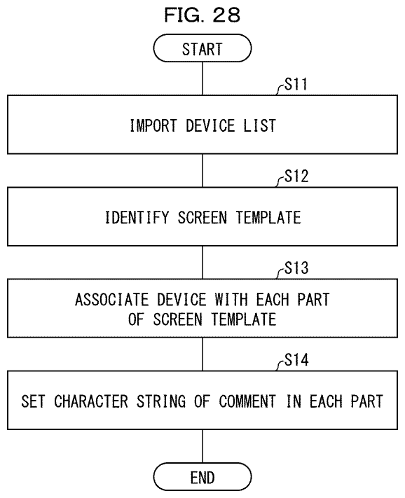

The following will describe creation of screen data by the PC 6. FIG. 28 is a flowchart showing a procedure of creation of a screen by the PC 6. FIG. 26 is a diagram showing a device list 400A which is obtained when the PC 2 outputs, in the CSV format, a portion listing devices on the command list 100. FIG. 27 is a diagram showing a device list 400B which is obtained when the PC 2 outputs, in the CSV format, a portion listing comments on the command list 100.

First, the export section 212 of the PC 2 outputs the devices on the device list 400 as the device list 400A in the CSV format, as shown in FIG. 26. In the device list 400A, the devices are written in combination with “PLC1”, which is the number of the PLC 4. Further, the export section 212 of the PC 2 extracts the comments on the device list 400, and outputs the device list 400B in which the comments are expressed in characters in the CSV format, as shown in FIG. 27.

As illustrated in FIG. 28, the import section 611 of the screen creating section 61 imports the device lists 400A and 400B that have been exported from the PC 2 (step S11). The association section 612 identifies a screen template on the basis of the device lists 400A and 400B that have been imported (step S12).

The association section 612 identifies the screen template, for example, from a correspondence relation between (i) a name (including a comment) described in the device list 400B and (ii) a name included in a corresponding screen template. For example, regarding a servomotor, in a case where screen templates for 48 axes have been prepared, respective screen templates include “01 axis name”, “02 axis name”, . . . , and “48 axis name” written as temporary names. The association section 612 identifies a screen template of a first axis, in a case where “servo A” is written, in the device list 400B, as the name of a servomotor corresponding to a first axis. Note that a method for identifying the screen template by the association section 612 is not limited to the above-described method.

The association section 612 associates, with respective parts in the screen template which has been identified, the devices on the device list 400A (step S13). In association of the devices, the association section 612 replaces, with the devices on the device list 400A, temporary devices that have been associated in advance with the respective parts.

Further, the association section 612 arranges, in the screen template in which some of the parts are not disposed, a part corresponding to a predetermined position. The association section 612, for example, disposes a part representing an operation button in a case where the device includes Y (input relay) as a device symbol.

The association section 612 sets, for each of the parts in the screen template identified, a comment on the device list 400B, and ends a process (step S14).

### Example of Creation of Screen Data

The following will describe an example of creating screen data in the above-described way.

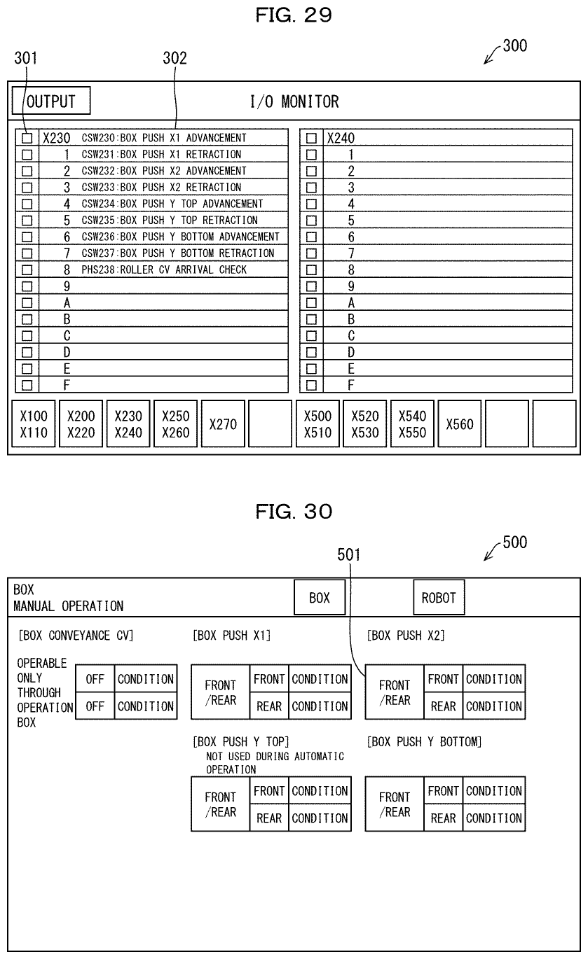

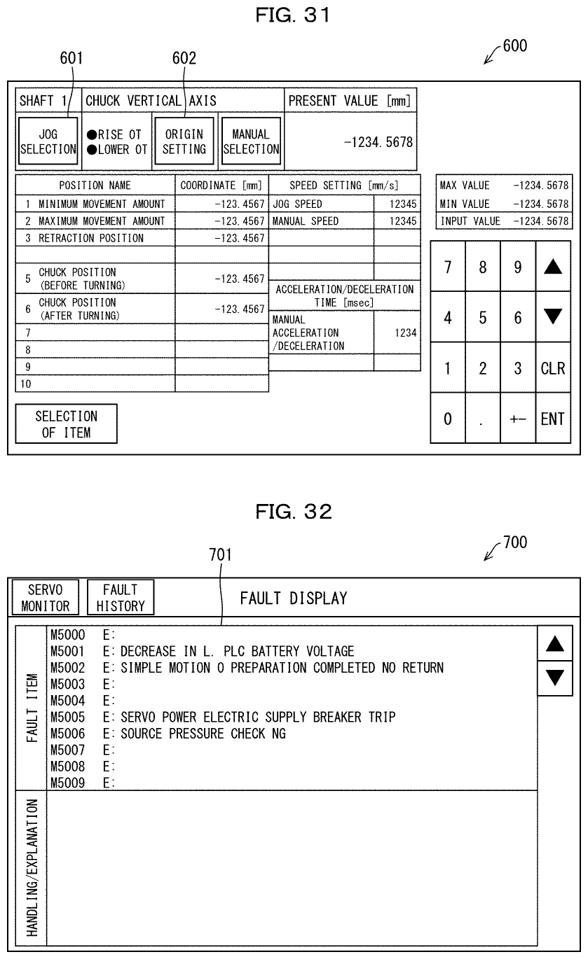

FIG. 29 is a diagram showing an I/O monitor screen 300. FIG. 30 is a diagram showing a tracking screen 500. FIG. 31 is a diagram showing an arm Z information display screen 600. FIG. 32 is a diagram showing a fault display screen 700.

The I/O monitor screen 300 illustrated in FIG. 29 is a screen that shows an I/O state, that is, a state of an input apparatus and an output apparatus. On the I/O monitor screen 300, a plurality of lamp parts 301 (objects) are arranged in respective rows, and character string display parts 302 (objects) which display devices and comments are arranged in the respective rows. With the lamp parts 301, respective devices are associated. In the character string display part 302, a device that was associated by the association section 612 and a comment that was set by the setting section 613 are written.

The tracking screen 500 illustrated in FIG. 30 has an operation button 501 (object). The operation button 501 is an input part for turning ON the internal relay of the device “10507” in the ladder program illustrated in FIG. 21. The operation button 501 is disposed by the association section 612.

The arm Z information display screen 600 shown in FIG. 31 has operation buttons 601, 602 (objects). The operation button 601 is an input part for turning ON the internal relay of the device “M15001” in the ladder program illustrated in FIG. 17. The operation button 601 is disposed by the association section 612. The operation button 602 is an input part for turning ON the internal relay of the device “M15004” in the ladder program illustrated in FIG. 18. The operation button 602 is disposed by the association section 612.

The fault display screen 700 illustrated in FIG. 32 has a fault display part 701 (object). The fault display part 701 is a display part for displaying the content of a fault when the respective internal relays of the devices “M5510”, “M5512”, and “M15001” in the ladder program illustrated in

FIG. 19 are turned ON. The fault display part 701 is provided in advance in the screen template. Further, a message to be displayed on the fault display part 701 is acquired from, for example, the device list 400B.

### Effects

The screen creating system 1002 of the present embodiment includes a PC 6 which has a screen creating section 61. The screen creating section 61 has an association section 612 and a setting section 613.

In the above-described configuration, the screen data can be automatically generated on the basis of the device list 400. This eliminates the need for performing a task of associating a device with a part. Further, by displaying the sequence name as a comment in a part on a screen, it is possible to save labor for separately setting the name of the part.

### Embodiment 3

The following description will discuss still another embodiment of the present invention. Note that for convenience of explanation, members having functions identical to those of respective members described in the foregoing embodiments are given respective identical reference numerals, and descriptions of those members will not be repeated.

### Overview of Diagram Creating System 1003

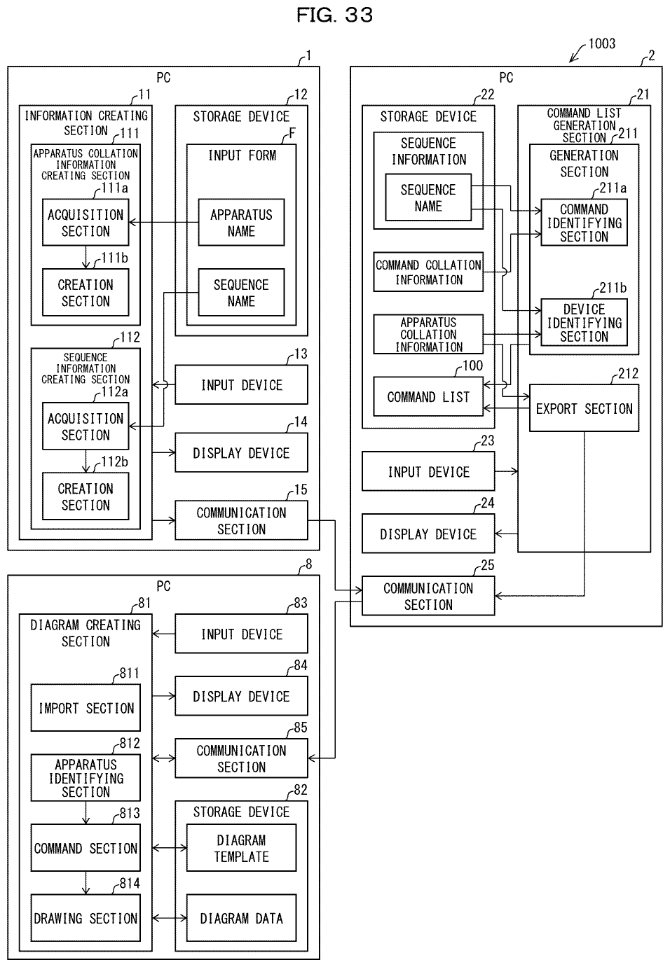

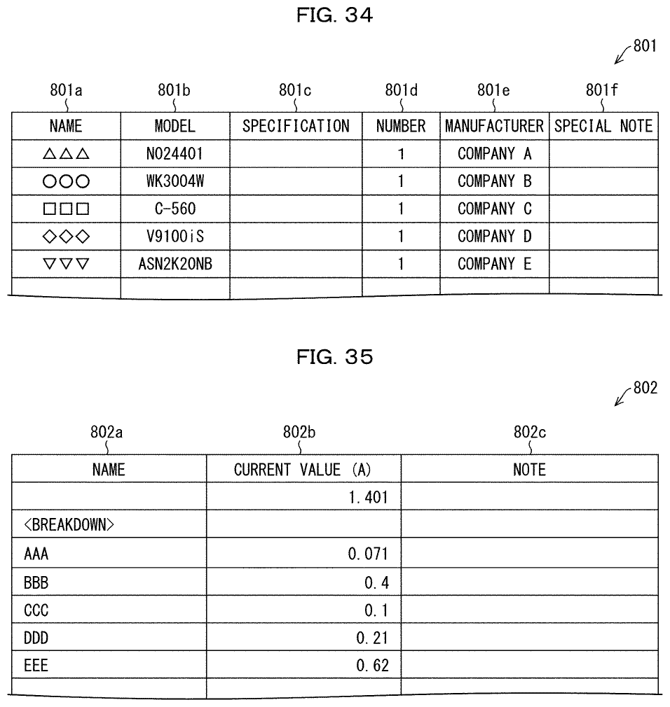

FIG. 33 is a block diagram illustrating a configuration of a diagram creating system 1003 in accordance with Embodiment 3. FIG. 34 is a diagram showing an apparatus information list 801 that is created by a PC 8. FIG. 35 is a diagram showing a current value list 802 that is created by the PC 8.

As illustrated in FIG. 33, the diagram creating system 1003 includes a PC 1 and a PC 2 in the same manner as the ladder program creating system 1001, and includes a PC 8 differently from the ladder program creating system 1001. The PC 8 is a personal computer, like the PCs 1 and 2.

The diagram creating system 1003 creates design information, creates a command list 100 on the basis of the design information, and automatically creates, by the PC 8, an electrical diagram on the basis of identification information obtained from the command list 100 and apparatus collation information.

The electrical diagram is a circuit diagram.

Specifically, the electrical diagram is a power supply diagram, a safety circuit diagram, a power diagram, a PLC configuration diagram, an input circuit diagram, an output circuit diagram, a terminal block diagram, or the like. The power supply diagram is a diagram representing a power supply and a circuit in a periphery of the power supply. The safety circuit diagram is a diagram representing a circuit having a safety function. The power diagram is a diagram representing a wiring related to a power section of a motor.

The PLC configuration diagram is a diagram representing a unit configuration of a PLC and a circuit in a periphery of the PLC. The input circuit diagram is a circuit diagram representing a connection configuration of an input unit of a PLC. The output circuit diagram is a circuit diagram representing a connection configuration of an output unit in a PLC. The terminal block diagram is a diagram representing a configuration of a terminal block and a wiring to the terminal block.

In the circuit diagram, a basic configuration of an apparatus 5 is defined for each system for executing a series of commands defined by the apparatus collation information and the command list 100. For this reason, a diagram template including a circuit graphic symbol corresponding to a configuration of each apparatus 5 is prepared for each circuit diagram. The storage device 22 stores such a diagram template in a file format.

The export section 212 of the PC 2 reads out the command list 100 and the apparatus collation information from the storage device 22. Then, the export section 212 converts the command list 100 and the apparatus collation information in the CSV format or the like and causes the communication section 25 to transmit, to the PC 8, the command list 100 and the apparatus collation information, so that the command list 100 and the apparatus collation information are exported.

### Configuration of PC 8

The PC 8 is configured as a diagram creating device for creating diagram data. In order to create the diagram data, the PC 8 includes a diagram creating section 81, a storage device 82, an input device 83, a display device 84, and a communication section 85. The input device 83 receives an operation made by a user, such as making an instruction to create diagram data. The display device 84 displays a user interface screen for receiving the operation.

In order to create the diagram data, the diagram creating section 81 has an import section 811, an apparatus identifying section 812, a command section 813, and a drawing section 814. The diagram creating section 81 stores, in the storage device 82, the diagram data created.

The import section 811 imports the command list 100 and the apparatus collation information that were exported in the CSV format.

The apparatus identifying section 812 identifies, with reference to the apparatus collation information, an apparatus name corresponding to a device that matches the device obtained from the command list 100. The apparatus identifying section 812 may identify the apparatus name directly from the apparatus collation information. Further, the command section 813 generates a graphic symbol drawing command to draw the circuit graphic symbol corresponding to the apparatus name thus identified. The command section 813 specifically selects, as the command, a file name of the diagram template described above that corresponds to a system which is determined on the basis of the apparatus name identified. Associating the system and the diagram template with each other is incorporated in the command section 813 as a command creation function, but may be stored in the storage device 22.

The command section 813 generates a wiring drawing command to draw, for a plurality of circuit graphic symbols in the system which are defined by the diagram template, a wiring corresponding to a connection relation between the circuit graphic symbols. In this way, the command section 813 combines and generates the file name and the drawing command as a command.

The command section 813 generates a name assignment command to assign an identified apparatus name as a name to be disposed at a predetermined position in a circuit graphic symbol corresponding to the apparatus name. In a circuit graphic symbol in the diagram template, a position where the name is to be disposed is set. Therefore, the command section 813 generates the name itself as a name placement command.

The command section 813 generates an I/O assignment command to assign a device obtained from the command list 100 and the apparatus collation information, as an I/O number that is to be disposed at a predetermined position(s) of the input unit (input circuit) and/or the output unit (output circuit) of the PLC and that corresponds to the device. In the input unit and the output unit in the diagram template, a position where the I/O number is to be disposed is set. Therefore, the command section 813 generates the device as the command.

The command section 813 generates a drawing command on the basis of various information corresponding to the apparatus name. In a case where an information list drawing command for drawing an apparatus information list is to be generated, the command section 813, specifically, includes, as a list, various information for each apparatus name and generates the information list drawing command by converting the various information from the list into the CSV format or the like. In a case where the apparatus information to be individually created, the command section 813 generates, as an individual drawing command, the various information for each apparatus name and stores, in the storage device 82, the information thus generated.

As illustrated in FIG. 34, the apparatus information list 801 includes a name column 801a, a model column 801b, a specification column 801c, a number column 801d, a manufacturer column 801e, and a special note column 801f. The name column 801a is a column in which an apparatus name, a name corresponding to the apparatus name, or the like is written. The model column 801b is a column in which a code that represents a model of the apparatus 5 is written. The specification column 801c is a column in which a specification of the apparatus 5 is written. The number column 801d is a column in which the number of apparatuses 5 is written. The manufacturer column 801e is a column in which a manufacturer of the apparatus 5 is written. The special note column 801f is a column in which a special note regarding the apparatus 5 is written.

Note that information written in the apparatus information list is not limited to the information shown in FIG. 34, but may include other information. Further, in the apparatus information list 801, a list of information regarding, for example, parts associated with the apparatus 5 may be written.

The command section 813 calculates a current value that is to be caused to flow in the apparatus 5 on the basis of the above-described various information corresponding to the apparatus name. The command section 813, specifically, calculates the current value on the basis of a predetermined calculation formula and on the basis of the various information described above. Further, the command section 813 generates a current value list drawing command to display the current value list on the basis of the current value thus calculated. The command section 813, specifically, generates the command by outputting, in the CSV format, the current value and related information that is relevant to the current value.

As illustrated in FIG. 35, the current value list 802 includes a name column 802a, a current value column 802b, and a remark column 802c. The name column 802a is a column in which the apparatus name itself, a name corresponding to the apparatus name, or the like is written as the related information. The current value column 802b is a column in which the current value column calculated is written. The remark column 802c is a column in which various remarks regarding the current value are written as the above-described related information.

Note that in the current value list 802, in addition to the information shown in FIG. 35, other information regarding the current value may be written.

The drawing section 814 copies and draws a set circuit graphic symbol which has a shape predetermined in accordance with the apparatus name, at a position predetermined in accordance with the apparatus name and on the basis of the graphic symbol drawing command and the wiring drawing command of the command section 813. Further, specifically, the drawing section 814 reads out, on the basis of the file name of the command from the command section 813, a diagram template having the file name from the storage device 22. In addition, the drawing section 814 draws the circuit graphic symbol in the diagram template, and also draws, as appropriate, a line that represents the wiring between the circuit graphic symbols. The drawing section 814 stores, in the storage device 82, the diagram data created.

Note that the drawing section 814 may draw, in a diagram template including no set circuit graphic symbol, not only a wiring but also a circuit graphic symbol without copying the set circuit graphic symbol. To this end, the command section 813 generates a graphic symbol drawing command to draw the circuit graphic symbol itself. The drawing section 814 draws the circuit graphic symbol in accordance with the graphic symbol drawing command.

The drawing section 814 draws the name at a predetermined position in the circuit graphic symbol, on the basis of the name assignment command of the command section 813. The drawing section 814 draws the I/O number on the basis of the I/O assignment command of the command section 813.

The drawing section 814 draws the apparatus information list on the basis of the information list drawing command of the command section 813. Specifically, the drawing section 814 draws the apparatus information list by writing pieces of the above-described various information in the CSV format or the like, one by one, into the diagram template in a tabular format.

The drawing section 814 draws the current value list on the basis of the current value list drawing command of the command section 813. Specifically, the drawing section 814 draws the current value list by writing, one by one in the diagram template in a tabular format, the current value and pieces of the related information in the CSV format or the like which are generated as a command of the command section 813.

Note that the drawing section 814 may be constituted by a general-purpose drawing program (drawing software). Such a drawing program includes Excel (registered trademark) available from Microsoft Corporation. The drawing section 814 is realized by, for example, various drawing functions described by Visual Basic for Applications (VBA) which is a programming language in Excel (registered trademark). The command section 813 causes a drawing function to be carried out by accessing such a drawing function.

Further, the drawing section 814 may be configured by general-purpose computer aided design (CAD). The drawing section 814 may directly operate CAD software. Further, in a case where a file to be drawn is a DXF file, the file is composed of a text file, and includes, as information of the circuit graphic symbol, graphic symbol information such as a line and a basic graphic symbol (e.g., a circle and a quadrangle). The drawing section 814 is configured as a file editor program. The drawing section 814 opens the diagram data that has been created in the file format, and draws and visualizes the circuit graphic symbol. In contrast, the command section 813 is configured by a text editing program such as a text editor. Accordingly, the command section 813 generates, as a drawing command(s), rewriting of the graphic symbol information into a text file, addition of the graphic symbol information, and/or the like.

### Creation of Diagram Data by PC 8

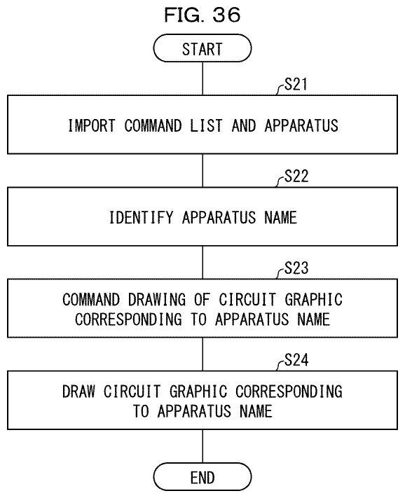

The following will describe creation of diagram data by the PC 8. FIG. 36 is a flowchart illustrating a procedure of creation of a diagram by the PC 8.

First, the export section 212 of the PC 2 outputs the command list 100 and the apparatus collation information in the CSV format.

As shown in FIG. 36, the import section 811 of the diagram creating section 81 imports the command list 100 and the apparatus collation information that have been exported from the PC 2 (step 21). The apparatus identifying section 812 identifies the apparatus name on the basis of the command list 100 and the apparatus collation information (step S22). The apparatus identifying section 812 searches for the apparatus collation information by using the device on the command list 100 as a key, and extracts the apparatus name corresponding to the device. Thus, the apparatus identifying section 812 identifies the apparatus name for each command in the command list 100.

Here, the various information described above corresponding to the apparatus 5 is associated with the apparatus name. For example, in a case where the apparatus 5 is a motor, the apparatus name is associated with various information such as a capacity, a rated current, a model, a cable name, and an electric capacity as various information pertaining to the motor. Therefore, when the apparatus name is identified, the various information corresponding to the apparatus name is also identified.

Note that the apparatus name may be identified by a method other than the above-described method. For example, as described above, the apparatus identifying section 812 may identify the apparatus name directly from the apparatus collation information.

The command section 813 gives a command to draw a circuit graphic symbol corresponding to the apparatus name thus identified (step S23). The command section 813 also instructs, as drawing of the circuit graphic symbol, to assign a name in the circuit graphic symbol, assign an I/O number in the circuit graphic symbol, draw the apparatus information list, and draw the current value list in addition to drawing the circuit graphic symbol and the wiring.

Upon receipt of the command from the command section 813, the drawing section 814 draws the circuit graphic symbol corresponding to the apparatus name in the screen template (step S24) and creates diagram data. The drawing section 814 also carries out, in addition to drawing the circuit graphic symbol, assignment of a name in the circuit graphic symbol, assignment of an I/O number in the circuit graphic symbol, drawing of the apparatus information list, and drawing of the current value list on the basis of the various information associated with the apparatus name and the apparatus name.

### Example of Creation of Diagram Data

The following will describe an example of creating diagram data in the above-described way.

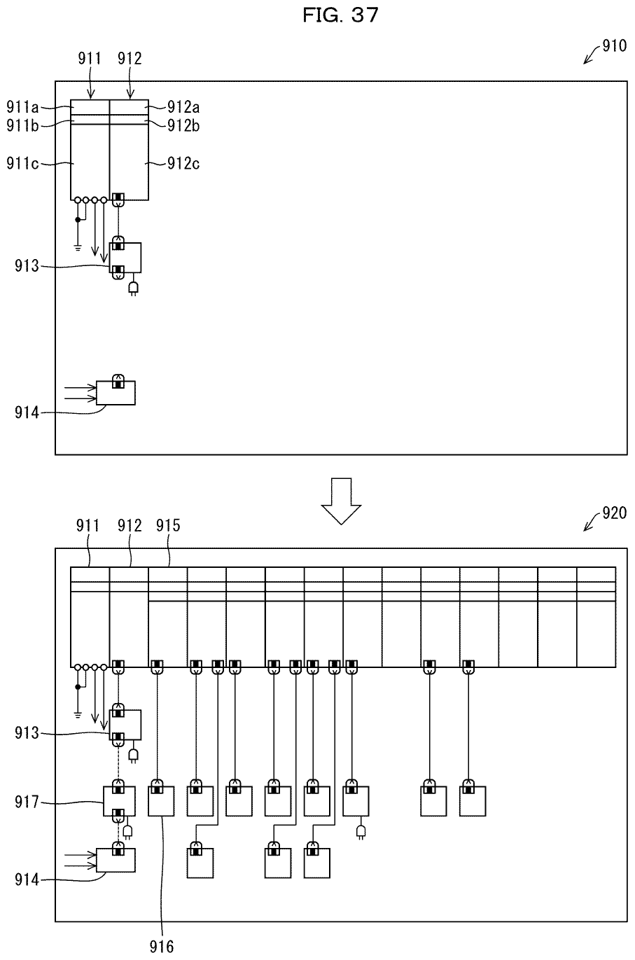

FIG. 37 is a diagram showing a diagram template 910 that has been prepared by the PC 8 and diagram data 920 that was created by the PC 8 on the basis of the diagram template 910. A diagram shown on an upper side of FIG. 37 illustrates the diagram template 910 for creating a PLC configuration diagram, and a diagram shown on a lower side of FIG. 37 is diagram data 920 of a PLC configuration diagram created on the basis of the diagram template.

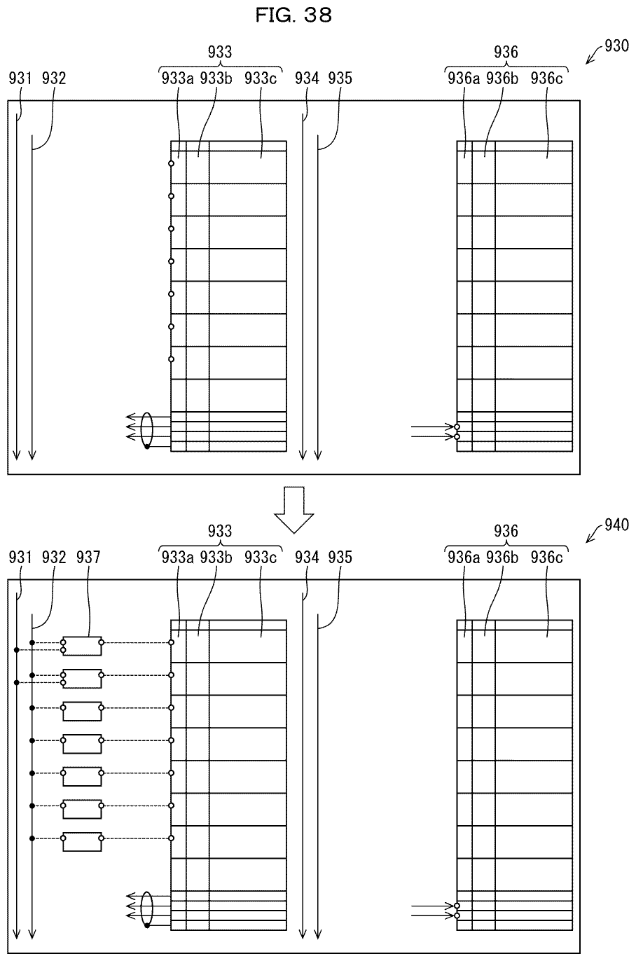

FIG. 38 is a diagram showing another diagram template 930 that has been prepared by the PC 8 and other diagram data 940 that was created by the PC 8 on the basis of the diagram template 930. A diagram shown on an upper side of FIG. 38 is a diagram template 930 for creating an input circuit diagram of a PLC, and a diagram shown on a lower side of FIG. 38 is diagram data 940 of an input circuit diagram of the PLC that was created on the basis of the diagram template 930.

The diagram template 910 illustrated on the upper side of FIG. 37 includes circuit graphic symbols 911 to 914 as a minimum configuration for creating a PLC configuration diagram. The circuit graphic symbol 911 represents a power supply unit of the PLC. The circuit graphic symbol 912 represents a CPU unit of the PLC.

The circuit graphic symbols 911 and 912 have respective name entry columns 911a and 912a, model entry columns 911b and 912b, and information entry columns 911c and 912c. The names described above are entered in the name entry columns 911a and 912a. In each of the model entry columns 911b and 912b, a code representing the model described above is entered. In each of the information entry columns 911c and 912c, various information other than the name and the model is entered. The circuit graphic symbol 913 represents an interface circuit on a PLC side. The circuit graphic symbol 914 represents a touch panel apparatus like the operation display device 7 (see FIG. 24) described above.

Upon receipt of the graphic symbol drawing command from the command section 813, the drawing section 814 adds circuit graphic symbols 915 to 917 by copying and drawing set circuit graphic symbols, as shown on the lower side of FIG. 37. The drawing section 814 thus creates the diagram data 920. The circuit graphic symbol 915 represents a unit (e.g., an input unit or an output unit) other than the power supply unit and the CPU unit of the PLC. The circuit graphic symbol 916 represents various apparatuses 5 (e.g., a sensor, a switch, a motor, and an electromagnetic valve) for input and output which are connected to the above-described units. The circuit graphic symbol 917 represents an interface circuit on a touch panel apparatus side. Further, upon receipt of the wiring drawing command from the command section 813, the drawing section 814 draws, with a line, each of wirings between the circuit graphic symbols 913 and 917, between the circuit graphic symbols 914 and 917, and between the circuit graphic symbols 915 and 916.

The diagram template 930 shown on the upper side of FIG. 38 includes circuit graphic symbols 931 to 936 as a minimum configuration for creating the input circuit diagram of the PLC. The circuit graphic symbols 931 and 932 each represent a power supply wiring of the PLC, in an input circuit on the left. The circuit graphic symbol 933 represents each input unit of the PLC, in the input circuit on the left. The circuit graphic symbols 934 and 935 each represent a power supply wiring of the PLC, in an input circuit on the right. The circuit graphic symbol 936 represents each input unit of the PLC, in the input circuit on the right.

The circuit graphic symbols 933 and 936 have, respectively, terminal number entry columns 933a and 936a, I/O number entry columns 933b and 936b, and name entry columns 933c and 936c. In the terminal number entry columns 933a and 936a, the terminal number of each input unit is entered. In the I/O number entry columns 933b and 936b, the I/O number described above is entered. In the name entry columns 933c and 936c, the name described above is entered.

Upon receipt of the graphic symbol drawing command from the command section 813, the drawing section 814 adds a circuit graphic symbol 937 between the circuit graphic symbol 933 and the circuit graphic symbols 931 and 932 according to need by copying and drawing a set circuit graphic symbol, as shown on the lower side of FIG. 38. The drawing section 814 thus creates the diagram data 940. The circuit graphic symbol 937 represents an apparatus 5 such as a relay, a switch, or the like.

### Effects

The diagram creating system 1003 of the present embodiment includes a PC 8 which has a diagram creating section 81. The diagram creating section 81 has an apparatus identifying section 812, a command section 813, and a drawing section 814.

In the above configuration, a circuit graphic symbol is drawn on the basis of the command list 100 and the apparatus collation information. Thus, the graphic symbol data can be automatically generated. Therefore, it is possible to greatly reduce labor required for diagram creation. Further, creation of a circuit diagram corresponding to a system that is configured so as to be centered on the PLC 4 and the apparatus 5 can be carried out in cooperation with creation of the ladder program described above.

Further, the drawing section 814 draws a name at a predetermined position in the circuit graphic symbol on the basis of a command from the command section 813. This makes it possible to automate writing of a name assigned to a circuit graphic symbol such as a block of a circuit diagram.

Further, the drawing section 814 draws the I/O number described above at a predetermined position in the circuit graphic symbol, on the basis of the command from the command section 813. This makes it possible to automate writing of the I/O number.

Further, the drawing section 814 draws the above-described apparatus information list, on the basis of the command from the command section 813. This makes it possible to check, with reference to the apparatus information list created, the name, model, manufacturer, and specification of the apparatus in the circuit diagram created.

Further, the drawing section 814 draws the current value list described above, on the basis of the command from the command section 813. Since a current that is caused to flow in each apparatus 5 is defined as a rated current value, it is possible to easily select, for example, a part associated with the apparatus 5 by calculating a current value. Further, by calculating a power with use of the current value, it becomes possible to automatically select control apparatuses such as a breaker and a DC power source and to automatically select a wire size and the like.

### Software Implementation Example

The functions of the PCs 1, 2, 3, 6, and 8 (hereinafter referred to as “device”) can be realized by a program (e.g., a command list creating program, a screen creating program, and a diagram creating program) for causing a computer to function as the device. The program causes the computer to function as control blocks (in particular, the information creating section 11, the command list generation section 21, the ladder program creating section 31, the screen creating section 61, and the diagram creating section 81) of the device.

In this case, the device includes, as hardware for executing the program, a computer that includes at least one control unit (e.g., a processor) and at least one storage device (e.g., storage devices 12, 22, 32, 62, 82). By the control unit executing the program with use of the storage device, the functions described in the foregoing embodiments are realized.

The program can be stored in at least one computer-readable non-transitory storage medium. The storage medium can be provided in the device, or the storage medium does not need to be provided in the device. In the latter case, the program can be supplied to the device via an arbitrary wired or wireless transmission medium.

Further, one or some or all of respective functions of the control blocks described above can be realized by a logic circuit. For example, an integrated circuit in which a logic circuit that functions as each of the control blocks is formed is also encompassed in the scope of the present invention. In addition, the respective function of the control blocks can be realized by, for example, a quantum computer.

Further, each process described in the above embodiments may be executed by artificial intelligence (AI). In this case, the AI may be operated by the control unit or may be operated by another device (e.g., an edge computer or a cloud server).

### Additional Remark

The present invention is not limited to the embodiments above, but can be variously altered within the scope of the claims. The present invention also encompasses, in its technical scope, any embodiment derived by appropriately combining technical means disclosed in differing embodiments.

### REFERENCE SIGNS LIST

1 PC (information creating device)
2 PC (command list creating device)
4 PLC (control device)
6 PC (screen creating device)
7 operation display device
8 PC (diagram creating device)
100 command list
112a acquisition section
112b creation section
211 generation section
211a command identifying section
211b device identifying section (identification information identifying section)
301 lamp part (object)
302 character string display part (object)
501, 601, 602 operation button (object)
701 fault display part (object)
801 apparatus information list
802 current value list
812 apparatus identifying section
813 command section
814 drawing section
912 to 917, 931 to 936 circuit graphic symbol
F1 storage section

1. A command list creating device comprising
a generation section that associates (i) a command which defines sequence control carried out by a control device and (ii) identification information of an apparatus connected to the control device and generates a command list, on the basis of sequence information which describes, in operation order of the apparatus, a compound name indicating an operation of the apparatus,
the compound name including an apparatus name that indicates the apparatus and an operation name that indicates the operation of the apparatus,
the generation section including:
a command identifying section that refers to command collation information in which a correspondence relation between the compound name and the command is defined in advance, and identifies the command corresponding to the compound name that was sequentially read out from the sequence information; and
an identification information identifying section that refers to apparatus collation information in which a correspondence relation between the apparatus name and the identification information is defined in advance, and identifies the identification information corresponding to the apparatus name included in the compound name that was sequentially read out from the sequence information.

2. The command list creating device according to claim 1, wherein:
the command collation information defines in advance the correspondence relation between the compound name and a related command that is related to the command corresponding to the compound name;
the command identifying section identifies the related command corresponding to the compound name that was sequentially read out from the sequence information; and
the generation section associates, in the command list, the related command with the identification information

3. The command list creating device according to claim 2, wherein the related command is a permission command that permits execution of a next command in a case where a specific condition is satisfied.

4. The command list creating device according to claim 1, wherein the generation section associates the compound name with the command in the command list.

5. (canceled)

6. A non-transitory computer-readable storage medium storing a command list creating program for causing a computer to function as the command list for creating device recited in claim 1.

7. An information creating device that creates the sequence information used in the command list creating device recited in claim 1, comprising:
an acquisition section that acquires the compound name from a storage section in which the compound name is stored; and
a creation section that creates the sequence information by receiving an input made by a user, in which the compound name acquired by the acquisition section is arranged in the operation order.

8. The information creating device according to claim 7, further comprising the storage section.

9. A screen creating device comprising
an association section that displays, with reference to the identification information obtained from the command list created by the command list creating device recited in claim 1, a state of the apparatus acquired from the control device, and that also associates the identification information with an object which constitutes a screen to be displayed by an operation display device which gives, to the control device, a control instruction received via a touch panel.

10. (canceled)

11. A non-transitory computer-readable storage medium storing a screen creating program for causing a computer to function as the screen creating device recited in claim 1.

12. A screen creating device comprising:
an association section that, with reference to the identification information obtained from the command list created by the command list creating device recited in claim 4, displays a state of the apparatus acquired from the control device, and that also associates the identification information with an object which constitutes a screen to be displayed by an operation display device which gives, to the control device, a control instruction received via a touch panel; and
a setting section that sets, on the screen, the compound name corresponding to the identification information so as to cause the compound name to be displayed in the object.

13. (canceled)

14. A non-transitory computer-readable storage medium storing a screen creating program for causing a computer to function as the screen creating device recited in claim 12.

15. A diagram creating device comprising:
an apparatus identifying section that identifies the apparatus name which corresponds to the identification information identical to the identification information obtained from the command list which has been created by the command list creating device recited in claim 1, the apparatus identifying section identifying the apparatus name with reference to the apparatus collation information;
a command section that generates a command for drawing a circuit graphic symbol corresponding to the apparatus name identified; and
a drawing section that draws, on the basis of the command, the circuit graphic symbol of a shape predetermined in accordance with the apparatus name, the drawing section drawing the circuit graphic symbol at a position predetermined in accordance with the apparatus name.

16. The diagram creating device according to claim 15, wherein:
the command section generates a command to assign the apparatus name which has been identified, as a name to be disposed at a predetermined position in the circuit graphic symbol corresponding to the apparatus name; and
the drawing section draws the name at the predetermined position on the basis of the command.

17. The diagram creating device according to claim 15, wherein:
the command section generates a command to assign the identification information obtained from the command list, as an I/O number to be disposed at a predetermined position of at least one of an input circuit and an output circuit that corresponds to the identification information; and
the drawing section draws the I/O number on the basis of the command.

18. The diagram creating device according to claim 15, wherein:
the command section generates a command to draw an apparatus information list on the basis of various information corresponding to the apparatus name; and
the drawing section draws the apparatus information list on the basis of the command.

19. The diagram creating device according to claim 15, wherein:
the command section calculates a value of current caused to flow in the apparatus, on the basis of various information corresponding to the apparatus name, and generates a command to display a current value list on the basis of the value of the current calculated; and
the drawing section draws the current value list on the basis of the command.

20. (canceled)

21. A non- transitory computer-readable storage medium storing the diagram creating program for causing a computer to function as the screen creating device recited in claim 15.

22. A command list creating method comprising
a generation step of associating (i) a command which defines sequence control carried out by a control device and (ii) identification information of an apparatus connected to the control device and generating a command list, on the basis of sequence information which describes, in operation order of the apparatus, a compound name indicating an operation of the apparatus,
the compound name including an apparatus name that indicates the apparatus and an operation name that indicates the operation of the apparatus,
the generation step including:
a command identifying step of referring to command collation information in which a correspondence relation between the compound name and the command is defined in advance, and identifying the command corresponding to the compound name that was sequentially read out from the sequence information; and
an identification information identifying step of referring to apparatus collation information in which a correspondence relation between the apparatus name and the identification information is defined in advance, and identifying the identification information corresponding to the apparatus name included in the compound name that was sequentially read out from the sequence information.

23. An information creating method for creating the sequence information used in the command list creating step recited in claim 22, comprising:
an acquisition step of acquiring the compound name from a storage section in which the compound name is stored; and
a creation step of creating the sequence information by receiving an input made by a user, in which the compound name acquired in the acquisition step is arranged in the operation order.
